(19) United States
(12) Patent Application Publication
(10) Pub. No.: US 2010/0027379 A1
(43) Pub. Date: Feb. 4, 2010

(54) Ultrasonic Through-Wall Communication (UTWC) System

(76) Inventors: Gary Saulnier, East Greenbush, NY (US); Henry Scarton, Troy, NY (US); David Shoudy, Arlington, MA (US); Pankaj Das, San Diego, CA (US); Andrew Gavens, Niskayuna, NY (US)

Correspondence Address: NOTARO & MICHALOS P.C., 100 DUTCH HILL ROAD, SUITE 110, ORANGEBURG, NY, 10962-2100, US

(21) Appl. No.: 12/443,878

(22) PCT Filed: Oct. 1, 2007
(86) PCT No.: PCT/US07/80071

§ 371 Date: Apr. 1, 2009

Related U.S. Application Data
(60) Provisional application No. 60/848,840, filed on Oct. 2, 2006.
(60) Provisional application No. 60/947,714, filed on Jul. 3, 2007.

(51) Int. Cl. H04B 1/02

(52) U.S. Cl. 367/137

(57) ABSTRACT

Apparatus for communicating information across a solid wall has one or two outside ultrasonic transducers coupled to an outside surface of the wall and connected to a carrier generator for sending an ultrasonic carrier signal into the wall and for receiving an output information signal from the wall. One or two inside ultrasonic transducers are coupled to an inside surface of the wall and one of them introduces the output information signal into the wall. When there are two inside transducers inside the wall, one receives the carrier signal and the second transmits the carrier after it is modulated by the output information from the sensor. When there is one inside transducer, the output information from the sensor is transmitted by changing the reflected or returned signal from the inside transducer. A power harvesting circuit inside the wall harvests power from the carrier signal and uses it to power the sensor.

### CROSS-REFERENCE TO RELATED APPLICATIONS

This application claims priority from U.S. Provisional Patent Applications 60/848,840 filed Oct. 2, 2006 and 60/947,714 filed Jul. 3, 2007, both of which are incorporated here by reference.

### STATEMENT OF GOVERNMENT INTEREST

The Government has certain rights to this invention since it was created in part under a contract with the U.S. Department of Energy.

### FIELD AND BACKGROUND OF THE INVENTION

The present invention relates generally to the field of communication and, in particular, to wireless communication using ultrasonic energy.

There are presently no commercial products available that communicate digital information through a thick solid (e.g. steel) wall channel using ultrasonic techniques. In applications which require the use of a solid (e.g. steel) wall pressure vessel, it is often desirable to monitor the conditions inside the pressure vessel through the use of various sensors. The environment inside a pressure vessel is typically hostile and volatile, with the possibilities of high temperature and high pressure in a gaseous or liquid environment. When attempting to convey sensor readings to the outside of the pressure vessel, conventional wired and wireless communication techniques are not ideal. Wireless communication is not possible because of the electromagnetic shielding property of the solid wall channel. Drilling holes in the solid wall for wires to pass through is also not ideal, because this breaches the integrity of the wall which may lead to reduced system lifetime and a greater chance of pressure vessel wall failure.

U.S. Pat. No. 6,343,049 to Toda discloses an ultrasonic transmitting and receiving system for digital communication using a piezoelectric substrate and an interdigital transducer (IDT) with a coded pattern.

U.S. Pat. Nos. 6,037,704 and 5,982,297 to Welle disclose an ultrasonic data communication system which includes first and second transducers coupled together through a coupling medium for communicating input and output undulating pressure waves between the transducers for the transfer of input and output data between an external controller and an embedded sensory and actuating unit. An internal processor powers the second embedded transducer to generate ultrasonic waves into the medium that are modulated to send the data from the embedded sensor so that considerable energy is needed for the embedded circuits.

A need thus remains, for providing improved communication through walls, in particular, thick solid walls.

### SUMMARY OF THE INVENTION

It is accordingly an object of the present invention to provide a new through-wall communication apparatus and method.

In order to work around the limitations of the prior art, the present invention is a system that conveys data across the solid (e.g. steel) wall channel (called the wall communication channel) using ultrasonic communication techniques. No holes are required since the solid wall channel readily conveys compression/rarefaction waves at ultrasonic frequencies with little attenuation. Prior work in this area demonstrated the feasibility of ultrasonic communication [see refs. 1, 2]. Several different communication configurations were implemented and compared.

The system according to the present invention is characterized by minimal complexity on the inside of the pressure vessel, while still allowing for reliable communication at sufficient data rates. Also, the ability to deliver power to the inside electronics is desired, since the pressure vessel may be sealed for an extended period of time making battery replacement difficult or impossible.

Accordingly, another object of the invention is to provide an apparatus and a method for communicating information (such as multiple sensor data) from inside a wall to outside the wall, using one or two outside ultrasonic transducers on the outside of the wall to send an ultrasonic carrier signal into the wall and to receive a reflected output information containing ultrasonic signal from the wall. An inside ultrasonic transducer on the inside of the wall reflects the information containing ultrasonic signal into the wall. A carrier generator drives the outside ultrasonic transducer to generate the ultrasonic carrier signal and a detector arrangement connected to the one, or if there are two, the other outside ultrasonic transducer detects the information from the information containing ultrasonic signal. A sensor arrangement is connected to the inside ultrasonic transducer for reading information on the inside of the wall and for supplying the information to the inside ultrasonic transducer for generating the reflected information containing ultrasonic signal.

Another object of the invention is to provide an apparatus for communicating information across a solid wall that has one or two outside ultrasonic transducers coupled to an outside surface of the wall and connected to a carrier generator for sending an ultrasonic carrier signal into the wall and for receiving a reflected output information signal from the wall with an inside ultrasonic transducer coupled to an inside surface of the wall that generates the reflected output information signal into the wall, and a detector on the outside that detects the reflected output information, and a sensor connected to the inside transducer that reads information inside the wall and supplies it to the inside transducer for generating the reflected output information, with a power harvesting circuit inside the wall that harvests power from the carrier signal and uses it to power the sensor.

According to the present invention the carrier for the data transmission from inside the wall (e.g. a 1 MHz CW) is generated at the outside. Data is sent by varying the electrical load on the inside transducer which changes its acoustic impedance which, in turn, modulates the size of the reflected carrier signal. This change in the reflected carrier is detected at the outside transducer (either the transmitting transducer or a second outside transducer) to receive the data. This approach has the advantage over the prior art that the inside circuit does not need to include an oscillator nor does it need to supply power to the inside transducer. Thus simplicity is gained and lower power requirements for the inside circuit is achieved.

The invention also includes a control circuit that enables the system to operate in burst mode when very little power is available to the inside circuit. This control circuit senses when sufficient energy has been collected for the collection of a data set from the sensors and enables the inside circuits to transmit that data. At other times, the inside circuit is inactivated except for the power harvesting system. A control circuit on the inside of the wall is provided to achieve these functions.

Another object of the invention is to provide a double-hop approach that uses four transducers made up of two pairs axially aligned on opposite sides of the wall where one pair is used to convey a carrier signal from the outside to the inside, the received carrier being converted to an electrical signal by the inside transducer, modulated (using any of a wide variety of analog or digital modulation techniques) and fed to the other inside transducer which sends it to the other outside transducer.

It is noted that for the purpose of this disclosure, relative words such as “inside” and “outside” are meant to include their opposite meaning and are not meant as a limitation except as they relate to each other.

The present invention can also be used for two-way communication through a solid wall and the wall may be steel and/or concrete steel, ceramics, polymers, composites, and also could be a fluid layer, or other material, and may be in any environment including but not limited to pressure vessels for boilers or other vessel walls, and environments of high and low pressures, temperature or other environments bounded by the solid wall. Vessels could also be vacuum vessels, environmental chambers, water/oil/chemical tanks, space vehicles, bell jar, etc.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic diagram of a three transducer hybrid embodiment of the invention;

FIG. 2 is a schematic diagram of a two transducer embodiment of the invention;

FIG. 3 is a diagram of a power harvesting architecture of the invention;

FIG. 4 is a schematic diagram of a rectification part of the power harvesting circuit, in particular, a voltage doubler circuit of the invention;

FIG. 5 is a schematic diagram of a voltage monitoring and switching circuit of the invention;

FIG. 6 is a signal graph showing power build-up in the power harvesting circuit of the invention;

FIG. 7 is a block diagram of the inside circuit board of the invention;

FIG. 8 is a schematic diagram of the opening and shorting circuit of the invention;

FIG. 9 is a schematic diagram of a comparator input limiting and clock generation circuit of the invention;

FIG. 10 is a schematic diagram of a passive envelope detection circuit of the invention;

FIG. 11 is a schematic diagram of two of the four stages of the conductivity meter triangle wave generation and IV conversion of the invention;

FIG. 12 is a schematic diagram of two remaining stages of the conductivity meter for rectification and low-pass filtering;

FIG. 13 is a block diagram of the outside circuit of the invention;

FIG. 14 is a schematic diagram of a full-wave rectifier circuit of the invention;

FIG. 15 is a schematic diagram of a DC removal circuit with lowpass filtering of the invention;

FIG. 16 is a schematic diagram of a 2^{nd} order KRC filter circuit of the invention;

FIG. 17 is a schematic diagram of a fixed 1.5 V offset circuit of the invention;

FIG. 18 is a scope image showing an envelope change prior to envelope detection according to the invention;

FIG. 19 is a scope image showing the envelope detection signal according to the invention;

FIG. 20 is a scope picture of 280 bps for the two-transducer embodiment of the invention;

FIG. 21 is a scope picture of 5 kbps for the two-transducer embodiment of the invention;

FIG. 22 is a scope picture of 20 kbps for the two-transducer embodiment of the invention;

FIG. 23 is a scope picture of 50 kbps for the two-transducer embodiment of the invention;

FIG. 24 is a graphical user interface or GUI for a user control interface program of the invention;

FIG. 25 is a CPLD startup sequence flowchart of the invention;

FIG. 26 illustrates an inside circuit board command word of the invention;

FIG. 27 is a CPLD normal operation flowchart of the invention;

FIG. 28 is a power-up sequence flowchart for the DSP code of the present invention;

FIG. 29 is an output circuit board stage 1 adjustments flowchart of the present invention;

FIG. 30 is an output circuit board stage 2 adjustments flowchart of the present invention;

FIG. 31 is a flowchart for the main program loop during DSP normal program operation;

FIG. 32 is a perspective view of the bottom part of an inside housing of the invention;

FIG. 33 is a perspective view of the top part of the inside housing of the invention;

FIG. 34 is a schematic representation of a transducer arrangement for testing the system of the present invention; and

FIG. 35 is schematic diagram of another embodiment of the invention using two inside transducers and a double hop technique.

### DESCRIPTION OF THE PREFERRED EMBODIMENTS

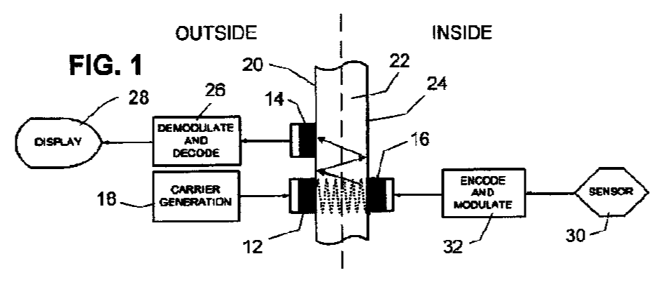

Referring now to the drawings, in which like reference numerals are used to refer to the same or similar elements, several transducer configurations with both the carrier generator and the receiver on the outside were investigated. In a three-transducer “hybrid approach” illustrated in FIG. 1, a transmitter 12 and a receiver 14 are adjacent one another and are acoustically coupled to an outside surface 20 of a solid (e.g. steel) wall 22. A modulating transducer 16 is acoustically coupled on the inside surface 24, directly across from, e.g. axially aligned with, the transmitting transducer 12. While axial alignment of the transducers is intended to optimize the fraction of the applied power that reaches the modulating transducer on the inside, it is not necessary to have such alignment. A continuous-wave (CW) or pulsed carrier signal generated by a carrier generator 18, is applied through the transmitter 12, travels through the wall channel, is amplitude (AM) modulated through the reflection off of the open or is substantially open, or shorted or substantially shorted inside transducer 16, and then received at the adjacent receiver transducer 14. The AM modulation seen at the receiver 14 can be detected through methods such as envelope detection, for example by a demodulator and decoder 26, and the results shown, for example, on a display 28. The AM modulation is produced by varying the size of the signal that is reflected by the receive/modulating transducer 16 by changing its acoustic impedance. This acoustic impedance change is introduced by changing the electrical load on the receive or modulating transducer. For example, binary data can be sent by placing a small-valued impedance (referred to as a “short” for simplicity) across the electrical terminals of the transducer output for a “0” and large-valued impedance (referred to as an “open” for simplicity) across the electrical terminals for a “1”. If the applied ultrasound is pulsed, the load can be changed on a per-pulse basis to send data at a baud rate that is equal to the pulse repetition rate. A receiver 14 can process the reflected pulses and detect the transmitted data. Higher-order amplitude modulation is possible by having a larger set of impedance values to apply to the inside transducer. For instance quaternary or 4-ary modulation would require the use of 4 different impedance values.

Both analog and digital modulations, for example analog amplitude modulation and digital amplitude-shift keying, can be used. In both cases, information is conveyed through the amplitude of the reflected pulses. A potential problem with analog amplitude modulation, however, is that it may be difficult to vary the load impedance in a linear way in response to the analog signal and/or it may be difficult to detect small changes in the reflected signal with sufficiently-high signal-to-noise ratio for conveying sensor readings.

A major advantage of the system is that the ultrasonic carrier signal, as either a series of pulses or as CW, is generated on the outside of the wall and conveyed to the inside where it is modulated with the data. Consequently, neither an oscillator nor a pulser is required on the inside thereby reducing both the electric power requirements and complexity of the inside circuitry. In addition the demodulation of the returned signal on the outside is simplified by having precise knowledge of the carrier signal, e.g. the timing of the pulses or frequency of the CW signal.

Electrical power for the inside system is derived from the applied carrier signal using power harvesting techniques. The received acoustic power is converted to an alternating current (AC) electrical signal by the inside transducer and subsequently converted into a direct current (DC) power source for the inside system. Power harvesting can be performed for both pulsed and CW carriers.

Two-way communication is possible using this approach by modulating the carrier applied to the outside of the wall. A receiver transducer on the inside can demodulate this carrier to recover the data being conveyed from the outside to the inside. For conveying sensor data from the inside to the outside, the carrier received at the inside, which has already been modulated with the data from the outside, can be modulated a second time using the sensor data. Depending on the modulation being used, the receiver on the outside will make use of the known data transmitted from outside to inside and/or the actual modulated carrier sent from outside to inside in the demodulation process.

It was observed that the amplitude modulated data carrying signal seen at the electrical terminals of the receive or receiver transducer 14 also appears at the output of the carrier generator 18 in FIG. 1. In a second preferred embodiment, a “reflected power” approach removes the second outside transducer 14 and connects the demodulator and decoder 26 to the output of the carrier generator 18 through a resistive attenuation circuit. This approach has the advantage of using only a single pair of transducers.

This two-transducer approach using a single outside transducer 12 and a single inside transducer 16 is illustrated in FIG. 2 which will be described in detail later in this disclosure. Again the transducers are directly aligned, allowing for maximum power delivery to the inside but the system can operate without this alignment.

When the outside transducer 12 sends in a CW carrier, it concurrently receives the data, that is, the information containing amplitude modulated ultrasonic signal from the inside. When the inside transducer terminals are opened and shorted, e.g. by a MOSFET 34 that forms a modulation device part of a sensor means of the invention, the impedance looking into the body of the wall through the outside transducer 12, changes. This changes the signal magnitude across the outside transducer terminals, since the size of this signal is determined by the voltage divider formed by the output impedance of the driving, source 48, typically 50Ω and the electrical impedance presented by the inside transducer.

When the outside transducer 12 sends in a pulsed carrier, it receives the reflected ultrasonic pulse that has been amplitude modulated with the data during the intervals between the pulses. In other words, the outside transducer sends a carrier pulse and waits to receive the amplitude modulated reflection before applying the next carrier pulse.

Another advantage of this two-transducer apparatus and method is that since the transducers are axially aligned with each other across the wall, there is significantly less multi-path introduced by the channel between the inside transducer and receive transducer (i.e. the single outside transducer 12). Data rates of 100 times those attained by the three-transducer configuration of FIG. 1 have been achieved with this approach. Further, the electronics developed for the three-transducer hybrid approach can be applied directly to the two-transducer configuration by simply replacing the signal from the outside receive transducer with an attenuated version of the signal at the terminals of the outside transmit transducer.

Two custom circuit boards have been designed and built to implement the system of the invention, one for the outside of the pressure vessel, which will be referred to as the “outside circuit board”, and one for the inside, which will be referred to as the “inside circuit board”. The inside circuit board has the ability to open and short the transducer terminals, e.g. using the MOSFET (metal-oxide semiconductor field-effect transistor) 34, in order to send data from the inside to the outside for processing. In FIG. 2 the outside functions to be implemented by the outside circuit board are shown at 40 and the inside functions of the inside circuit board are shown at 50.

Additionally, inside functions 50, which for convenience will also be referred to as the inside circuit board, incorporate power harvesting circuit 36 enabling it to obtain electrical power for operation from the received acoustic power (refs. [3], [4], [5]). The inside circuit board 50 has the ability to concurrently harvest electrical power from the received acoustical power and send back data by opening and shorting the terminals. The board is able to sense the amount of power collected and, depending on the amount of power available, run in a continuous or burst mode. A data clock is generated by dividing down a clock waveform generated from the carrier wave.

The functions 40, or again for convenience, the outside board 40 uses an envelope detector and gain circuit 42 to find the changes in amplitude of the received signal. This is done by first rectifying the received signal and then low-pass filtering to retain only the envelope signal. A coherent demodulator can be used in place of the envelope detector, providing improved performance but having higher implementation complexity. The outside hardware is built around a digital signal processor (DSP) 44. The outside hardware system includes the DSP 44, a digital LCD display 46 and an RF amplifier 48 to amplify the carrier signal at the outside transducer 12 so that power delivery to the inside electronics can be accomplished.

Additionally, the electronics for two-way communication have been implemented on both boards. The outside board 40 has the ability to modulate the amplitude of the carrier applied to the wall and the inside board at 50 has an envelope detector 68 for detecting these amplitude changes. Possible uses for two-way communication include changing the data rate, determining which sensor data to transmit, and setting other operation modes of the inside board. In order to control two-way communication and overall system operation, software with a graphical user interface (GUI), which allows user control of the entire system from any PC with a USB connection has been developed. The interface lets the user select which modes of operation should be entered, display sensor readings, and log the received data as needed.

### Basic System Operation

The end goal of the system shown in FIG. 2 is the transmission of digital data from the “inside”, shown on the right, to the “outside”, shown on the left, through the use of ultrasound without any wires between the inside and outside electronics. On the outside, the Digital Signal Processor (DSP) 44 is the main processing unit that controls the system operation. On the inside, a CPLD (Complex Programmable Logic Device) 60 is the main processing unit.

In order to complete a full communication sequence, the DSP 44 first communicates with a Direct Digital Synthesis (DDS) Waveform Generator 62 of the outside circuit 40, providing a serial stream that instructs it to generate a sinusoid having the desired frequency.

The transducers used in the prototype system have a resonant peak at approximately 1 MHz and the selected carrier frequency is near that resonant frequency. Other transducers with a different resonant frequency may be used with the corresponding change in carrier frequency. The actual operating frequency may deviate slightly from the transducer resonant frequency because the system performance, both in terms of power delivered to the inside and the communications reliability, is highly frequency dependent due to the reverberations within the wall. For simplicity, the carrier frequency will be referred to as 1 MHz though it is not exactly that value. The choice of the optimal operating frequency for a specific set of parameters, e.g. wall thickness, wall material, transducer size, etc., can be determined by those skilled in the art. The use of the DDS, however, provides the DSP with the capability to select a desired frequency.

The 1 MHz sinusoidal output of the DDS chip 62 is passed through the RF amplifier 48 before being sent to the outside transducer 12. The amplitude of the input to the outside transducer is determined based on the channel conditions and the amount of power that needs to be delivered to the inside electronics. The outside transducer converts this electric signal into ultrasonic waves that propagate through the wall (e.g. through the solid steel of the wall) 22 toward the inside of the channel. The resulting 1 MHz acoustic wave can now be viewed as the carrier for the communication system.

On the inside of the channel, the electronics are used to convey data from multiple sensors 54 and 56 for example, back to the outside. In FIG. 2, for simplicity, two sensors are shown along with an analog-to-digital converter (ADC) 64. The number of sensors can easily be expanded in the real system with either more analog or digital devices. Currently, the inside electronics incorporate temperature and conductivity sensors. In one mode of operation, the Complex Programmable Logic Device (CPLD) 60 cycles through each of the sensors and retrieves the data from each sensor, either by reading from a built in serial interface on the device or by sampling with the ADC 64. The CPLD 60 then formats the data, adding framing bits to facilitate sensor data decoding and synchronization at the receiver. The CPLD uses the digital data from each of the sensors to produce the necessary sequence of electric shorts and open circuits between the transducer terminals to convey the information. The CPLD clock is generated directly from the 1 MHz carrier using a comparator circuit. This clock is then divided down to produce the data clock at the desired data rate, making the data rate an integer submultiple of the applied sinusoidal carrier.

As described earlier, the opening and shorting of the transducer terminals modulates the electrical load on the transducer that, in turn, changes the acoustical impedance seen by the incoming ultrasonic waves. The electrical load change is implemented by placing the MOSFET (metal-oxide semiconductor field-effect transistor) 34 across the two transducer terminals and having the CPLD 60 turn it on and off. For example, a logic 1 in the serial stream turns the MOSFET on, resulting in the shorting of the two transducer terminals. A logic 0 opens the transducer terminals by turning off the MOSFET.

The inside electronics 50 also harvests DC power to run the sensors and circuits from the ultrasonic signal. The inside electronics will either operate continuously or in a burst mode. In burst mode, the circuitry will wait until enough energy has been collected and then run for a short period of time until the stored energy is depleted. This cycle then repeats with a period that depends on the amount of received power and the power consumption of the devices using the DC power.

In the wall, multi-path phenomenon produces a standing wave due to the multiple reflections and tendency for the wall to resonate. As a result, any change in either the applied carrier wave or the impedance at the inside transducer will introduce a transient that will require a certain amount of time to diminish. This limits the achievable data rates when not using any advanced processing. As data rates are increased and approach the same order as that of time transient required to modify the multi-path standing wave, distortion due to inter-symbol interference (ISI) becomes a significant problem that affects the communication performance. Equalization algorithms can be used to remove the ISI and achieve higher data rates.

The signal on the outside transducer 12 is comprised of the transmitted carrier wave, standing wave in the steel, and the varying returned or reflected wave off of the inside transducer 16. In this system, when the inside transducer terminals are opened and shorted, the impedance looking into the steel block from the outside of the channel changes due to the variations in the returned or reflected wave off of the inside transducer. Since the RF amplifier driving the outside transducer has a nominal 50Ω source impedance, the signal on the outside transducer 12 is determined by a voltage division between the RF amplifier's source impedance and input impedance of the transducer. As the transducer impedance changes, the voltage division creates an envelope modulation without the need for a dedicated receiving transducer.

At the outside transducer 12, the polarity of the change in received signal amplitude due to opening and shorting the inside transducer 16 terminals cannot be directly predicted due to the multi-path standing wave. By opening or shorting the inside transducer terminals, several paths that comprise the standing wave will be affected. For example, by shorting the terminals, the paths hitting the inside transducer will tend to be absorbed. If these paths interfere destructively at the outside transducer, then the receive signal amplitude will increase. If they interfere constructively, then the receive signal amplitude would decrease upon shorting. The polarity can easily be detected and adapted to in the outside electronics. In general, there is only a small change in the envelope of the received signal, but it is observable and measurable.

Referring back to FIG. 2, once the ultrasonic wave reflects back and reaches the outside transducer 12, it is converted back into an electric signal for processing. First the signal is amplified and then the envelope detector circuit 42 is used. The envelope detector removes the carrier and tracks only the changes in signal. The envelope detector circuit output is then sampled and quantized by an analog-to-digital converter (ADC) 66 and sent as a serial stream of samples to the DSP 44. The sample rate of the ADC 66 is synchronized to the data rate, since the carrier frequency is known and the data rate is a known integer submultiple of the carrier frequency. In the embodiment of the invention illustrated, seven samples per data bit are taken. The DSP then takes these samples and is able to synchronize to the data by looking for the expected framing bits.

Upon obtaining symbol and frame synchronization, the DSP processes the received data and decodes the actual sensor readings that were sent, while periodically verifying synchronization. The sensor readings are then displayed using a digital LCD display unit 46.

A second method for displaying the sensor readings uses a serial communication digital I/O device that is controlled through a LabVIEW generated program. This approach allows the sensor readings to be sent from the DSP directly to a computer for display. Data logging and further processing can also easily be accomplished based on which information the user is interested in.

In FIG. 2, the control interface enables the user to instruct the system and DSP 44 to enter the various modes of operation. The control interface is implemented using LabVIEW software and the same serial communication device is used to display the sensor readings. There are various buttons and text boxes in the software that allow the user to pick the desired sensors, data rate, and modes of operation. Upon entering this information into the software, the command is sent via a serial stream to the DSP 44. If necessary the DSP conveys this command to the inside electronics by amplitude modulating the carrier wave. The inside electronics 50 have a simple envelope detector circuit with an ADC at 68 to receive these commands. Upon power-up, the inside electronics 50 first sits idle and waits to receive a command. Upon receiving the command, the command is executed until either it is completed, if it is a one-time command, or power levels drop too low, upon which it enters the power harvesting cycle again.

### Steel Block And Transducer Details

To test the invention a test block was configured with bare piezoelectric crystals mounted onto the steel. Bare crystals were used instead of commercially-packaged transducers in order to avoid the power and signal loss introduced by the damping in those devices. The steel block was 2.25 inches wide and the 1.0 inch diameter ultrasonic crystals are mounted using epoxy. All ultrasonic crystals had a nominal 1 MHz resonant frequency, though other resonant frequencies could be used. Another important advantage of using the bare ultrasonic crystals is their very low profile, i.e. they do not stick out very far from the steel. This is a significant advantage for the inside system since using a minimum amount of space for the communication system is important.

### Power Harvesting Design And Development

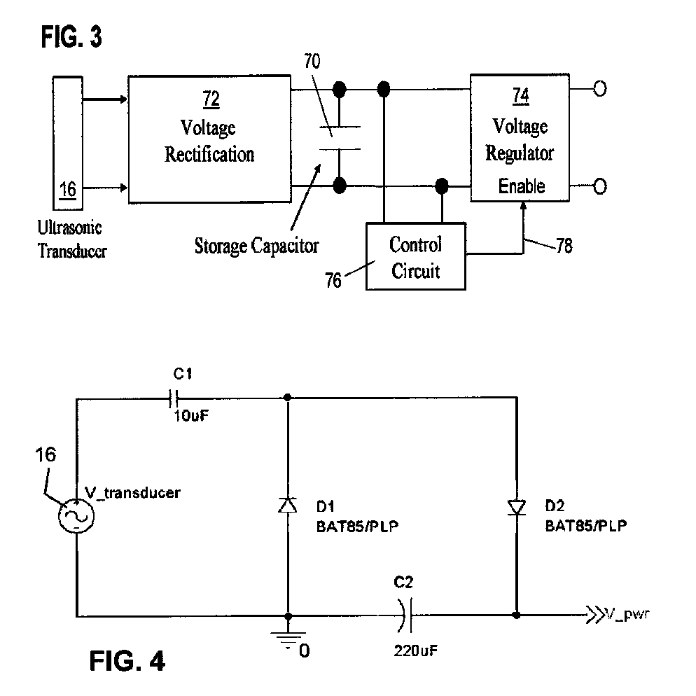

The inside circuit board requires very little power, drawing only 2.54 mA from the regulated 3.3V supply, for a total power consumption of 8.38 mW. This electrical power is provided by a power harvesting device 36 which produces DC power from the available acoustic power. The receive transducer resonates based on the vibrations in the steel and produces a sinusoidal voltage at the same frequency as the ultrasonic vibrations. This sinusoidal signal seen across the inside transducer terminals is rectified and stored as charge on a capacitor to make a DC power source (refs. 3 and 4) as will be explained in connection with FIG. 3.

The power harvesting circuitry 36 of FIG. 2 and of FIG. 3, allows the inside circuit board 50 to operate in two different modes. When enough acoustic power is available, an equilibrium between the amount of harvested power and the amount of power required to run the inside circuit board can be reached. These conditions result in the continuous mode of operation, where simultaneous power harvesting and communication of data from inside to outside is performed. If the available acoustic power is not sufficient for continuous operation, there is the option of running in burst mode. In burst mode, the electronics on the inside circuit board, with the exception of the power harvesting circuits, will initially be in stand-by mode as the acoustic power source is applied.

A switching circuit monitors the amount of charge stored on the charging capacitor and, once enough charge has been collected, the remainder of the board will be powered up. The circuit board will operate in this way for a short period of time using the energy stored on the capacitor. Once the stored charge is nearly depleted, the electronics will turn off again until the stored charge is restored. If the storage capacitor is sufficiently large, enough time becomes available for at least one full sequence of sensor readings to be transmitted while the capacitor is discharging. The circuit then waits for enough energy to be collected again and repeats the process of transmitting data in short disconnected bursts.

### Power Harvesting Circuitry

Referring now to FIG. 3, the power harvesting circuitry is used to convert the received sinusoidal wave at the terminals of the inside transducer 16 into a DC voltage via a voltage rectifier 72 that is stored on a capacitor 70. The DC voltage on the capacitor then becomes the power source in place of a battery by use of a voltage regulator 74 and control circuit 76. A reasonably large-valued capacitor 70 is used to store a significant amount of charge and provide an acceptably-long transmission time in burst mode as well as to protect against any sharp drops in the supply voltage due to current spikes. The maximum capacitor value is limited by the physical size of the device. A battery could also be used in place of the capacitor to provide greater charge storage.

The capacitor voltage is then regulated down to 3.3V and 1.8V by the voltage regulators 74 on the inside board 50. All other circuitry on the circuit board is powered by these 3.3V and 1.8V supplies and, therefore, when the voltage regulators are not outputting a voltage, the remainder of the inside circuit board is in shut down or sleep mode. In order to control when the regulator and, hence, the circuit board are turned on and off, the control circuit 76 is used to monitor the voltage on the storage capacitor 70. When the capacitor has charged to a high enough voltage, the control circuit 76 will bring the enable line 78 high, turning on the regulators 74 and turning on the inside board 50. The control circuit also monitors when the capacitor voltage has dropped to the point where the inside board should be powered down, in which case the control circuit will drive the enable line low.

The rectification is performed using a voltage doubler circuit shown in FIG. 4, which provides a larger DC voltage than a simple rectifier (ref. 7). The circuit has a capacitor C1 that is part of the rectification leg and a capacitor C2 that is the charge storage capacitor 70. On the positive half cycles of the received CW signal, a diode D2 is on and a diode D1 is off. On the negative half cycles, D1 is on and D2 is off. The circuit will charge up C2 to double the magnitude of the received CW signal at the inside transducer, minus two diode forward voltage drops. A large capacitor value is again used to provide insensitivity to current spikes and to allow for sufficient run time in burst mode. The positive terminal of C2 (V_pwr) is tied to the inputs of the on-board regulators. Also included in the circuitry, but not shown in FIG. 4, is a 12V Zener diode between V_pwr and ground. This Zener diode is included to ensure that the capacitor never exceeds 12V. The 12V threshold is chosen because this is the maximum input voltage that can be applied to the regulators without causing damage to the devices.

Under high acoustic power conditions when the power harvesting circuitry tries to charge C2 above 12V, the charging current will instead flow through the Zener diode, effectively dumping the extra power and keeping the voltage on C2 unchanged.

### Power Harvesting Control Circuit

The final piece in the power harvesting system is the control circuit 76 in FIG. 3. The purpose of this circuit is to control the shut down or enable pins of the regulators such that the electronics on the inside circuit board, other than the power harvesting circuit, are turned on and off based upon the storage capacitor's voltage. The circuit is much more complicated than a simple threshold device because it must have memory. More specifically, the regulators are not turned on until the capacitor reaches approximately 10V but, afterwards, they remain on until the voltage falls to approximately 3V. Therefore, for capacitor voltages between 3V and 10V, the regulators are either on or off depending on their previous state. The control signal for the enable lines of the regulators is generated through a low power custom designed discrete MOSFET transistor circuit which requires no external power supply. By using a very low power circuit, the efficiency of the power harvesting circuitry is not significantly diminished by power required to operate the control circuit. A unique feature of this circuit is that it does not require a constant power source for operation. The circuit instead monitors the variable power source V_pwr and turns the inside circuit board on and off based on high and low thresholds on V_pwr and whether or not the storage capacitor 70 is charging or discharging. The functionality of the circuit is shown in Table 1. It can be seen that the circuit actually takes on a hysteresis mode of operation, where switching thresholds vary based on the present state of the circuitry.

TABLE 1
Voltage Monitoring and Switching Circuit Operation Conditions

| | | 3 V < V_pwr < 10 V | 3 V < V_pwr < 10 V | |
|---|---|---|---|---|
| | V_pwr < 3 V | (Charging) | (Discharging) | V_pwr > 10 V |
| Inside Circuit | OFF | OFF | ON | ON |
| Board Status | | | | |

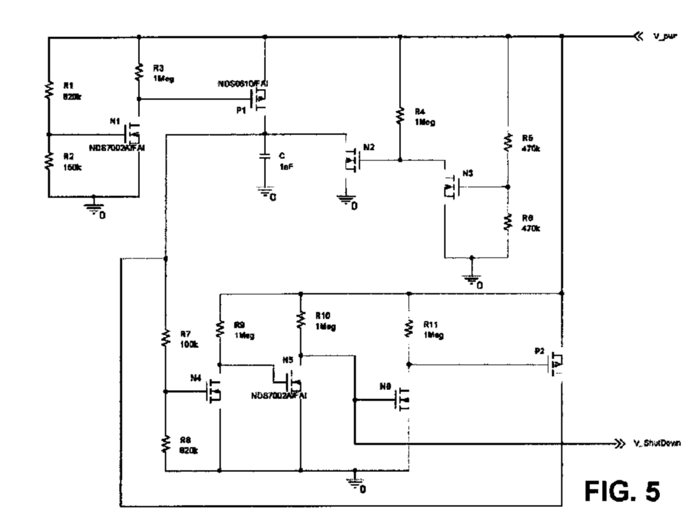

A full circuit schematic is shown in FIG. 5.

The output of the circuit of FIG. 5 is to drive V_ShutDown which is high or low based on the state of the input V_pwr. In the ‘on’ case, V_ShutDown is high and tracks V_pwr. In the ‘off’ case, V_ShutDown equals 0V. To obtain the desired hysteresis behavior, a memory element must be used to differentiate between whether the storage capacitor is being charged or discharged. This memory is implemented through the use of capacitor C, which is either charged to approximately V_pwr or is discharged to 0V. The voltage stored on this capacitor is monitored through NMOS transistor N4 and the resistor divider formed with R7 and R8. All transistors have a threshold voltage, V_{T}, of 2V. The voltage divider is configured such that when the voltage on C is greater than 3V, the gate of transistor N4 will be greater than 2V and N4 will turn on. When N4 is on, the gate of N5 is brought low, which turns off N5. When N5 is off, V_ShutDown tracks V_pwr, the regulator enable voltage is high, and the inside circuitry is turned ‘on’. Therefore, when the voltage on C is greater than 3V, the inside board will be turned ‘on’.

The remainder of the circuitry and transistors are used to control the voltage on capacitor C such that when the inside circuit board should be ‘on’, a high voltage on the capacitor exists and when the inside circuit board should be ‘off’, 0V is present on C. There are three sub-circuits that work together to accomplish this task. The first sub-circuit is used to charge up C when V_pwr is greater than 10V. If starting at an initial condition of V_pwr=0V and V_pwr rising (i.e. capacitor 70 charging), once V_pwr reaches 10V, N1 will be turned on, pulling the gate of P1 low. C will then be charged through the current flowing through the PMOS transistor P1. The second sub-circuit is used to discharge C when the voltage on V_pwr becomes less than 3V. When V_pwr is greater than 3V, N3 is on and the gate of N2 is pulled low, turning it off. On the other hand, when V_pwr is less than 3V, N3 is off, the gate of N2 is equal to V_pwr, and N2 will turn on, presenting a short circuit across the capacitor terminals, discharging the capacitor C. This will, in turn, result in V_ShutDown going low and the inside circuit board being turned off.

The third sub-circuit provides a feedback path to ensure that the voltage on C is approximately equal to V_pwr while V_pwr is greater than 3V and discharging. This circuit eliminates the possibility of the voltage on C drooping while V_pwr is still high enough to provide power, which could prematurely turn off the inside circuit board. When V_ShutDown is high, N6 is on and the gate of P2 is pulled low. P2 is then turned on and the feedback path is connected to the positive terminal of the capacitor. When V_ShutDown is low, N6 is off, the gate of P2 is high, P2 is off, and no feedback path exists. The feedback path allows the switching circuit to operate correctly by not letting C discharge when enough power is available for continuous operation of the inside circuit board. By combining the three sub-circuits just described, full control over the voltage on capacitor C can be obtained to implement the desired hysteresis behavior shown in Table 1. The voltage on this capacitor is monitored to produce the shut down voltages needed to turn on and off the inside circuit board.

The voltage monitoring and switching circuit is able to monitor a changing V_pwr voltage source without a constant voltage supply and control when the regulators are turned on and off. Also the switching circuit requires very little power so that the power harvesting process is not impeded through unnecessary power dissipation in the switching circuit. When V_ShutDown is high and the inside circuit board is on, the minimum input impedance of the circuit is 161.7 kΩ. With this input impedance the maximum current drawn will occur when V_pwr=12 V, equaling 12V/161.7 kΩ=74.2 μA. This small current is not very significant compared to the 2.54 mA that is required for the inside circuit board to operate continuously. The more critical requirement is that the switching circuit uses very little power when the inside circuit board is off and power is being collected. In this case, the minimum input impedance is 323 kΩ. This results in a maximum current of 10V/323 kΩ=30.9 μA and an average current of 6.5V/323 kΩ=20.1 μA, since the V_pwr voltage is changing from 3V to 10V when collecting power and operating in burst mode. There are also small leakage currents in the FET transistors, but these are very small in magnitude relative to these other currents and can be ignored. Overall, the circuit uses a very small amount of power and does not hinder the power harvesting process.

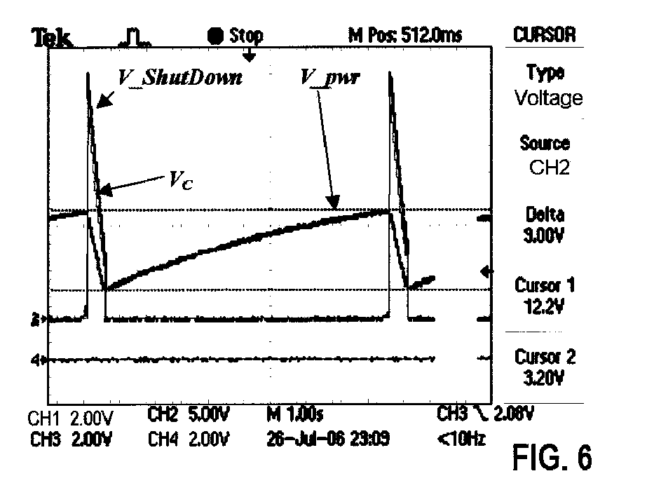

FIG. 6 shows captured waveforms that illustrate the operation of the control. The V_ShutDown and V_{C} (voltage on capacitor C) waveforms track each other very closely. The V_pwr waveform slowly rises from approximately 3V to 12V when V_ShutDown is low and the regulators for the inside circuit board are disabled. The rapid decrease in V_pwr occurs when the regulators are enabled and inside circuit board is running. When these waveforms were recorded, the upper threshold was configured to be 12V (it was later reduced to 10 V) and the system was operating with damped transducers. This configuration had very poor power transfer efficiency and burst mode operation was required. Approximately 6.5 seconds were required to charge the storage capacitor, followed by 0.5 seconds of run time and data transmission.

### Inside Circuit Board Details

The current version of the inside circuit board includes the power harvesting circuitry, as just described, and circuits which can detect the amplitude modulation of the received carrier signal for two-way communication. The board also includes two temperature sensors, one mounted on the board itself and a second that can be connected to a remote sensor via a pair of wires. The circuits for performing conductivity measurements are also included on the board, requiring the connection of a conductivity probe.

### Inside Circuit Board Components

The main processing unit on the inside circuit board is the Coolrunner-II XC2C256 CPLD by Xilinx, which has 80 user I/O pins, 16 function blocks, 256 macrocells, and requires 1.8V and 3.3V supplies.

The CPLD is a very low power device, having a quiescent current of 13 μA. With a clock rate of 1 MHz, the current consumption is approximately 400 μA.

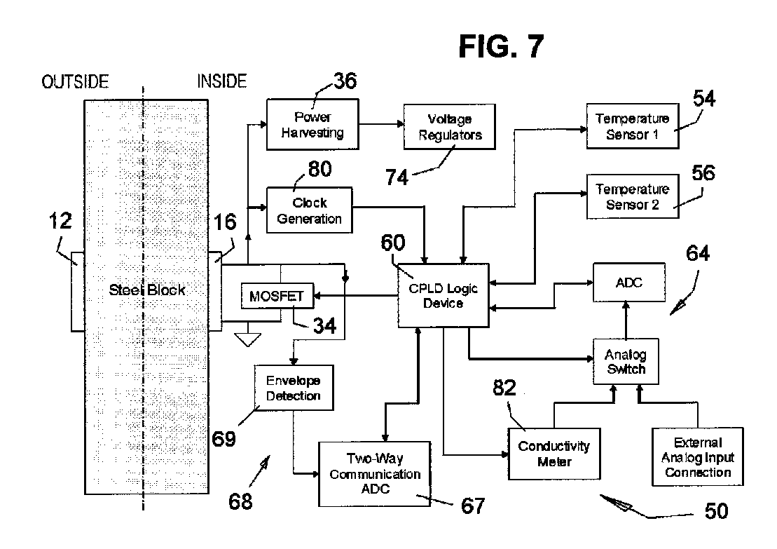

FIG. 7 is a simplified functional block diagram of the inside circuit board 50. The output of the inside transducer 16 is connected directly to several circuits which make up the transducer interface. The first is the power harvesting circuitry 36 as described previously. The charge storage capacitor voltage and V_ShutDown line from the control circuit are the inputs to the voltage regulators 74. The CPLD 60 requires 1.8 V and 3.3 V. All other circuitry uses 3.3 V only. Regulation is performed by MAX8881 regulators by Maxim, which come in both 1.8 V and 3.3 V variations. These regulators each consume only 3.5 μA of current during operation and can be put into shutdown mode through the V_ShutDown line.

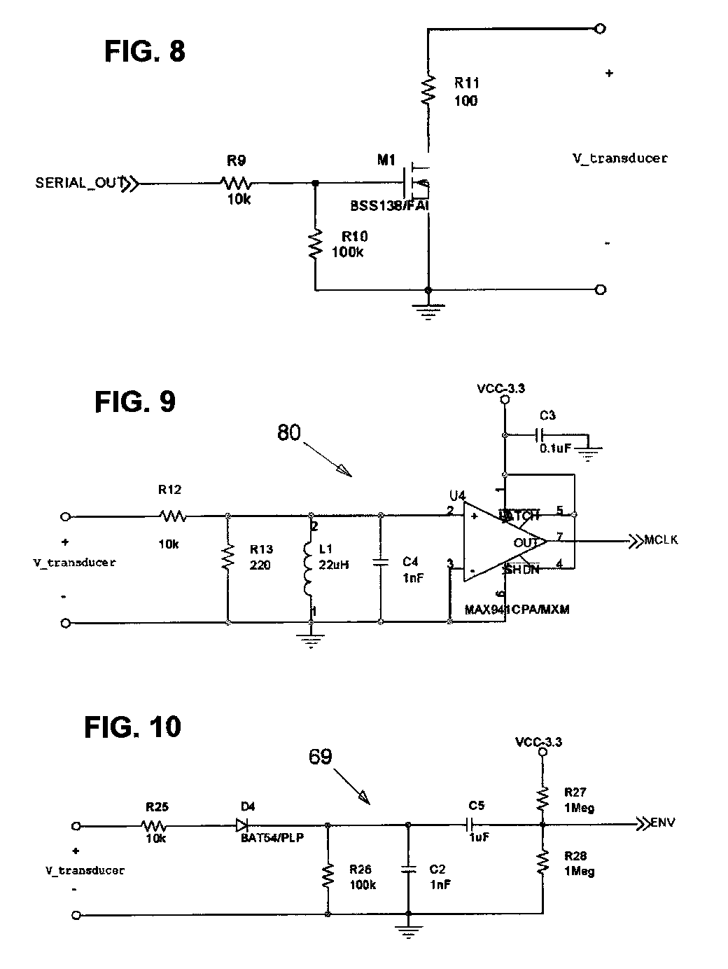

The opening and shorting circuitry used for changing the acoustic impedance of transducer 16 in FIG. 2 also connects directly to the transducer terminals as shown in FIG. 8. The circuit includes a large resistor between the gate of the MOSFET 34 and ground to serve as a pulldown resistor. This resistor makes sure that the FET is off on startup so that power is not being dumped. Also, there is a series resistor between the gate and the serial line on the CPLD 60. Without this resistor, it was found that when the regulators were in shutdown mode, a significant amount of current was traveling from drain to gate through the C_{GD} capacitance. This current then flowed through the serial data CPLD pin to ground. This process was wasting power and making the power harvesting less efficient. The addition of a 10 kΩ resistor in series with the gate limits the size of this current. The 100Ω resistor sets the minimum resistance placed across the transducer terminals when the MOSFET is on. This resistor is used because an actual short placed across the transducer would reduce the power harvesting efficiency (power dumped to ground) and, more importantly, interrupt the inside clock generation which depends on the continuous presence of the 1 MHz received signal.

A clock generation circuit 80 in FIG. 7 is also connected to the transducer terminals. This circuit uses a comparator in a zero-crossing detector configuration to produce a 1 MHz square wave from the received 1 MHz sinusoid. The MAX941 (Maxim) comparator is used because of its low power consumption, requiring only 350μA. Since the voltages seen at the inside transducer can be large, it is necessary to divide the voltage down before applying it to the comparator terminal. In order to do this, an RLC bandpass filter circuit with attenuation was developed to isolate the 1 MHz signal and attenuate other signals [ref. 8], as shown in FIG. 9. This filter helps ensure that noise does not cause extra pulses in the clock output. The RLC bandpass filter also removes any DC bias on the transducer signal that may be seen as a result of the power harvesting circuitry.

The last portion of the transducer interface circuitry is the envelope detection circuit 68 for two-way communication. This circuit is able to detect the AM modulation that will be applied to the 1 MHz carrier at the outside to convey commands to the inside board. The envelope detection is done through the use of a standard passive envelope detector 69, as shown in FIG. 10 (ref. 9). This circuit performs half-wave rectification through diode D4, current limiting through R25, and low-pass filtering through R26 and C2. The envelope detector has a dedicated ADC 67 for two-way communication, as shown in FIG. 7. The ADC 67 used here is the AD7468 by Analog Devices, a single-ended 8-bit ADC with a simple serial interface. In order to put the detected envelope into the center of the ADC input range, capacitor C5 in FIG. 10 removes the envelope's DC bias and R27 and R28 bias the envelope back up at a 1.65V DC level. This circuit was designed to be very low power such that it has little effect on the amount of power that can be harvested. In simulation, the circuit draws approximately 100 μA of current.

The CPLD interfaces with several serial devices. The AD7468 ADC is used to provide samples of the envelope for two-way communication. Additionally, a AD7466 ADC by Analog Devices is included on the board. This is a 12-bit 200 ksps low power ADC, which consumes a maximum 300 μA, with lower current values for lower sampling rates. This part has a simple serial interface and the sample rate determined by the serial clock (SCLK). This ADC has its input multiplexed by the ADG819 analog switch, which is controlled by the CPLD. The ADC can either sample the output of the conductivity meter circuit or an external ADC input, based on the status of the digital line to the analog switch.

This circuit board also has a remote diode temperature sensing integrated circuit (IC), the MAX6627 by Maxim. The chip has an onboard 12-bit ADC, giving 0.0625 degree Celsius resolution in temperature measurements. Two wires are run from the IC to an external diode-connected transistor for measurement of temperature at the point where the transistor resides. This device is also very low power, with a typical current consumption of only 30 μA, and communicates with the CPLD through a serial interface. An ADT7301 temperature sensor is also on the board to provide temperature readings at the board itself.

### Conductivity Meter

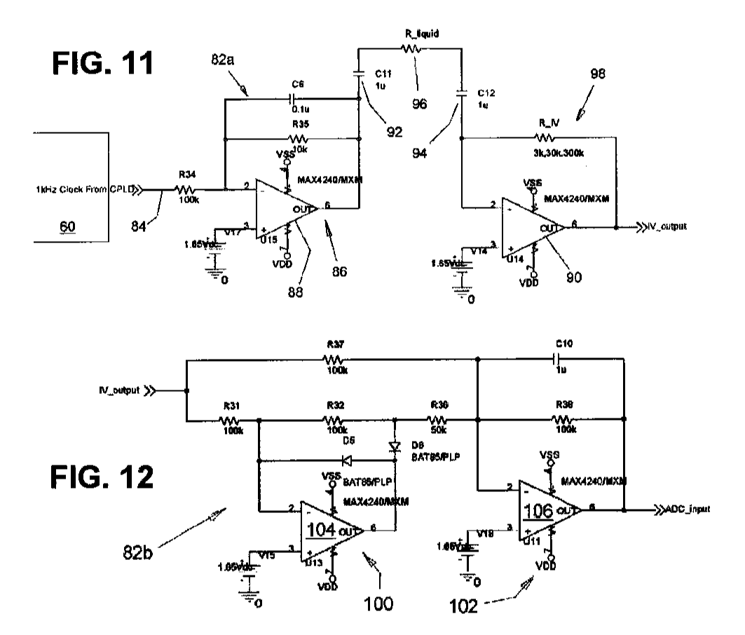

On the inside of the solid wall pressure vessel, there may be a liquid environment for which electrical conductivity measurements are desired. Therefore, an electrical conductivity meter 82 was included on the inside circuit board 50. A conductivity meter consists of a conductivity probe, which has two electrodes spaced apart by 1 cm, and an associated circuit. The geometry of the probe is designed to convert the conductivity of the liquid to a corresponding conductance value. A standard probe was purchased and a custom circuit was developed. The conductivity meter circuit 82 is implemented through a four stage signal chain, (similar to that done in refs. 10 and 11). The first two stages 82a are shown in FIG. 11. First, a 1 kHz square-wave clock is applied from the CPLD 60 at 84. This clock is generated by dividing down the 1 MHz system clock frequency. An attenuating active low-pass filter 86 converts the square wave into a small triangular-like waveform, which becomes the input to the conductivity probe. This signal, and all signals in the conductivity meter circuit, is biased up at 1.65 V, since only a 3.3 V single supply is available for the amplifiers. The amplifiers 88 and 90 are MAX4242 operational amplifiers, which are in a dual package with a very low quiescent current of only 10 μA per amplifier. To prevent polarization of the probe, DC blocking capacitors 92 and 94 are placed before and after the probe 96. The probe connection and conductivity of the liquid is represented by a resistance “R_liquid” in the FIG. 11 schematic, since, by measuring conductivity, you are effectively measuring 1/R_liquid.

Table 2 below shows the different conductance measurement ranges. The first stage of the circuit outputs a 50 mV amplitude (100 mV peak-to-peak) triangle wave. The conductivity of the liquid being measured will determine the amount of current flow through the liquid. A current-to-voltage (I-V) converter 98 then converts this current into a voltage. In each range, the maximum conductivity will produce a 1.5 V amplitude output triangle wave from the I-V converter while the minimum conductivity in each range will produce a 150 mV amplitude output triangle wave amplitude.

TABLE 2
Conductivity Meter Measurement Ranges

| | | | | Maximum IV | Minimum IV |
|---|---|---|---|---|---|
| Conductivity | | | | Output | Output |
| Range | R_liquid | R_{IV} | | Magnitude | Magnitude |
| 10 μS to 100 μS | 100 kΩ to 10 kΩ | 300 | kΩ | 1.5 V | 150 mV |
| 100 μS to 1 mS | 10 kΩ to 1 kΩ | 30 | kΩ | 1.5 V | 150 mV |
| 1 mS to 10 mS | 1 kΩ to 100Ω | 3 | kΩ | 1.5 V | 150 mV |

A 10 kΩ resistor can be switched into the circuit in place of the probe 96 for calibrating the conductivity meter. The calibration is necessary to help provide insensitivity to varying conditions, such as temperature, which may cause the circuit output to drift from its ideal value. A 10 kΩ resistor is chosen because this sits right in the middle of two of the three ranges in Table 2. Therefore, these two ranges can be calibrated, since 10 kΩ at the lower limit of one range and upper limit of a second range. In order to maintain constant calibration, the inside circuit board can be commanded to send back calibration information to the outside. The calibration reading is then used to apply the appropriate offset to the actual conductivity readings.

The last two stages 100 and 102 of the conductivity meter at 82b in FIG. 12 perform full-wave rectification and low-pass filtering of the triangle wave output of the I-V converter. The rectifier is biased to rectify at a 1.65 V threshold and uses the same low power MAX4242 amplifier chip at 104 and 106. The output of the conductivity meter at ADC_input will be a DC voltage proportional to the conductivity of the liquid between the probe electrodes. This voltage is sampled by the on-board ADC and the digital representation is sent across the channel by opening and shorting the transducer terminals. The outside hardware then decodes the received DC voltage measurement and converts it into a conductivity reading.

### Outside Circuit Board Details

The outside circuit board 40 of FIG. 2 utilizes a Digital Signal Processor (DSP) development board, which performs all of the signal processing, sensor data decoding, and control functions. To support a wide range of channel conditions, the outside circuit board provides multiple variable gains and a variable DC offset, all controlled by the DSP. The board includes an analog envelope detection signal chain, an on-board ADC, and an on-board DDS chip. The board also includes a carrier generation signal chain, which is able to amplitude modulate the transmitted CW output of the DDS chip. By putting an AM modulation on the transmitted carrier wave, information can be conveyed from outside to inside, creating a two-way communication link for selecting between various modes of operation of the inside electronics.

### Outside Circuit Board Operation

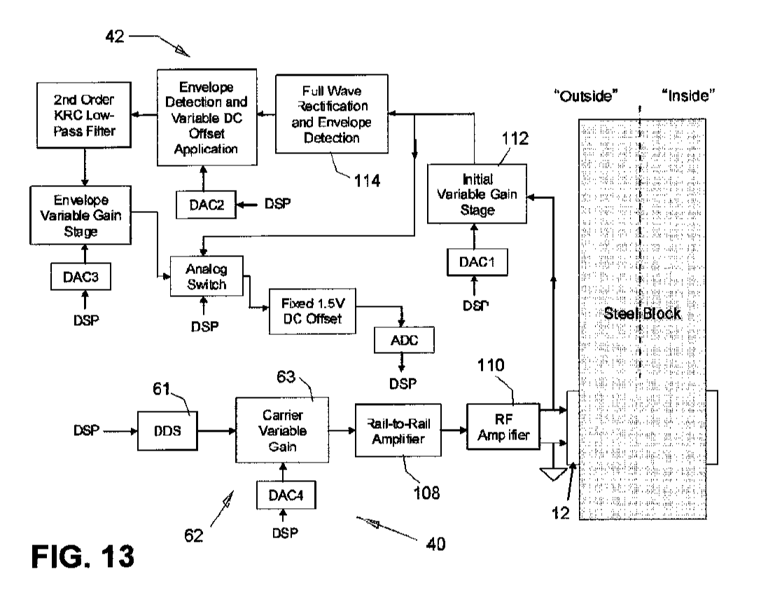

The outside circuit board system block diagram is shown in FIG. 13. A DDS chip 61 is an AD9832 by Analog Devices which runs off of a 25 MHz oscillator and has a 32-bit frequency tuning word and 10-bit resolution output DAC. The DDS chip accepts a serial stream from the DSP containing the frequency tuning word and adjusts its frequency output to match the desired frequency. The DSP runs a frequency sweep initially to determine the best operation frequency for maximum power delivery to the inside electronics and acceptable signal levels for communication.

Once the DDS chip outputs the desired frequency, nominally 1 MHz, a variable gain stage 63 is entered. The variable gain is performed using one of the channels of an AD602 Variable Gain Amplifier (VGA) by Analog Devices. The gain control voltage for the AD602 is supplied by one output of a four channel digital-to-analog converter (DAC). The DAC is controlled by the DSP and, hence, the gain of the carrier signal is controlled by the DSP. Gain changes are required to produce the amplitude modulation needed for two-way communication. By varying the DAC4 voltage, the gain of the carrier signal is varied to create this AM modulation. Timing for the AM modulation is generated internally in the DSP by dividing down the carrier frequency to match the data rate that the inside electronics will be expecting. With the 2.25 inch steel block, data rates of up to 5 kbps have been attainable for outside to inside communication. The system of the invention thus has input information means for sending information such as control signals to the inside of the wall.

When the ultrasonic communication system is being initialized, the carrier VGA gain is gradually increased while waiting for the inside electronics to harvest enough power. This adjustment is done by gradually bringing up the DAC4 voltage until an acknowledgment sequence is received from the inside electronics. This procedure, as well as the frequency selection and AM modulation timing, are discussed later. At the output of the VGA is a rail-to-rail amplifier 108 followed by an RF amplifier 110. The RF amplifier 110 is a large device that is not part of the outside circuit board. The amplifier provides 26 dB of additional gain on the output of the rail-to-rail amplifier. The rail-to-rail amplifier 108 is used because the output range of the VGA is only ±3 V when the power supplies are ±5 V. The rail-to-rail amplifier allows the carrier signal sent to the RF amp 110 to be approximately ±5 V. This added voltage swing is very significant since the inside electronics are performing power harvesting. Under bad channel conditions where power transfer is poor, or when many sensors are hooked up to the inside electronics, a large amount of power may need to be applied to the transmitting transducer. By maximizing the output of the amplifiers on the circuit board, the maximum amount of power is able to be transmitted into the system when needed.

Once the carrier signal level has been increased to the level where enough power is being harvested to run the inside electronics, the inside board begins modulating the acoustic impedance at the inner wall. This modulation produces an AM modulation that can be detected at the outside transducer 12.

The remainder of the outside circuit board is used to detect the envelope of this signal. The first stage is a variable gain stage 112, which uses the AD602 VGA chip. This device provides up to 30 dB of gain and is controlled through an analog input signal from the DAC. When operating in the three-transducer configuration, gain was often required to get an acceptable signal level. With the two-transducer configuration, however, a very large signal is present at the input to the outside circuit board, since this is the point where power is being applied to the outside transducer 12. Therefore an attenuating resistor was added prior to the VGA input. The VGA then amplifies the attenuated signal to obtain the desired signal level.

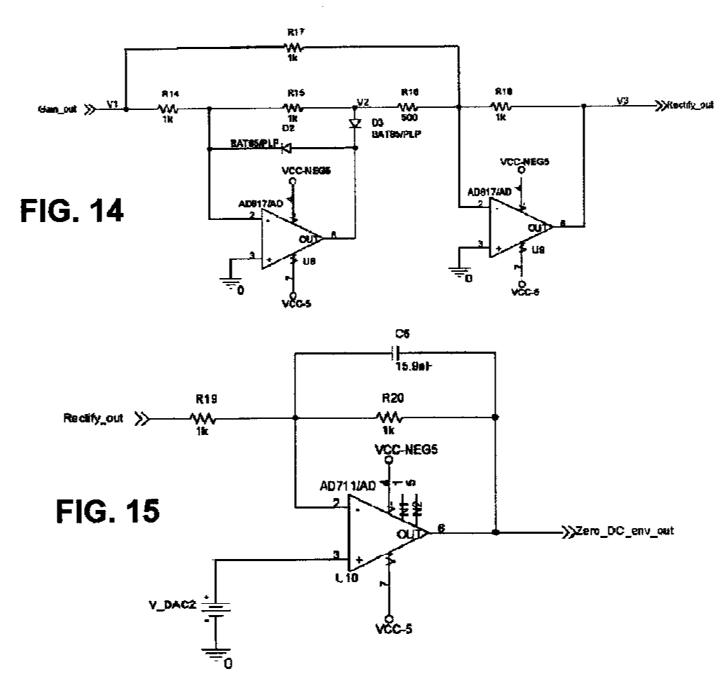

After amplification, the signal is processed by a full-wave rectifier circuit 114 (ref. 12). This circuit is shown in FIG. 14 with the exception that a capacitor has been added in the negative feedback path of the second amplifier, in parallel with R18, to provide additional filtering. Through the RC combination, the full-wave rectifier starts to perform envelope detection on the rectified carrier. Adding the capacitor converts the second amplifier into a summing low-pass filter. By using the second amplifier as an LPF, a higher order filter at the end of the signal chain is obtained without the use of more amplifiers. The rectifier output is fed to the envelope detector and DC offset removal circuits shown in FIG. 15. Here, a DSP controlled DC voltage is applied using DAC2 to remove the DC offset from the rectified signal.

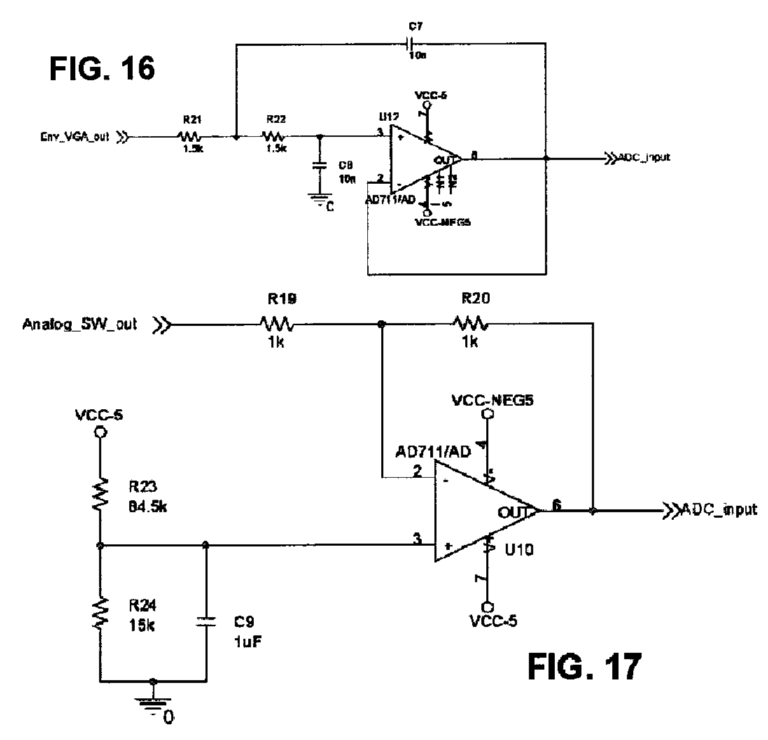

Following the DC offset removal and envelope detection, another LPF is used to further reduce the residual carrier signal. This is done through the use of a 2^{nd} order KRC low-pass filter circuit, as shown in FIG. 16. Once the residual carrier has been completely removed by low-pass filtering and the envelope resides at zero DC bias, the next stage is used to amplify the envelope. This amplification is done using another variable gain stage with the AD602 VGA. In order to accommodate the possibility of very small changes in the envelope, two AD602 VGA amplifiers are placed in series to provide the envelope gain. The gain is controlled through the third channel on the DAC, with up to 30 dB of achievable gain per amplifier.

After the envelope detection and envelope amplification, an analog switch and fixed offset amplifier circuit are used prior to the ADC input. The analog switch allows the DSP to select the input to the ADC, switching between the amplified signal before envelope detection and the envelope detector output, depending on the desired mode of operation. During normal operation, the envelope detector output will be selected as the input to the ADC. When initializing the DDS carrier gain or the received signal gain, the output of the first gain stage will be selected for sampling. By using an analog switch, the DSP, with the use of only one digital line, has full control over the signal paths that are selected for varying modes of operation. The analog switch is the ADG819 by Analog Devices which is a SPDT switch with 17 MHz bandwidth and an on resistance of 0.5Ω.

The AD7276 ADC by Analog Devices, having 12-bit resolution, a simple serial interface, and 3 MSPS sampling rate, is used to sample and quantize the output of the switch. The envelope, under ideal conditions, should look like a digital signal, with logic 1 and logic 0 values. Therefore, a great deal of resolution is not needed to recover the data from this signal, and theoretically, detection could be done through the use of a comparator with a 1.5V threshold. However, the actual sample values are desired for synchronization and further DSP processing, and hence an ADC is chosen for sampling the envelope.

The last part of the circuit board is a fixed 1.5V offset amplifier prior to the ADC input. The AD7276 is a single ended ADC that runs off of a 3.3V power supply. Therefore, offset circuitry is needed to put the envelope, or the output of the first gain stage, into the range of the ADC for sampling. This is done through a simple circuit as shown in FIG. 17. The capacitor C9 is included in the resistor divide to stabilize the DC voltage on the non-inverting terminal for a more precise 1.5V offset. The analog switch output signal is inverted by the gain of −1 in this circuit.

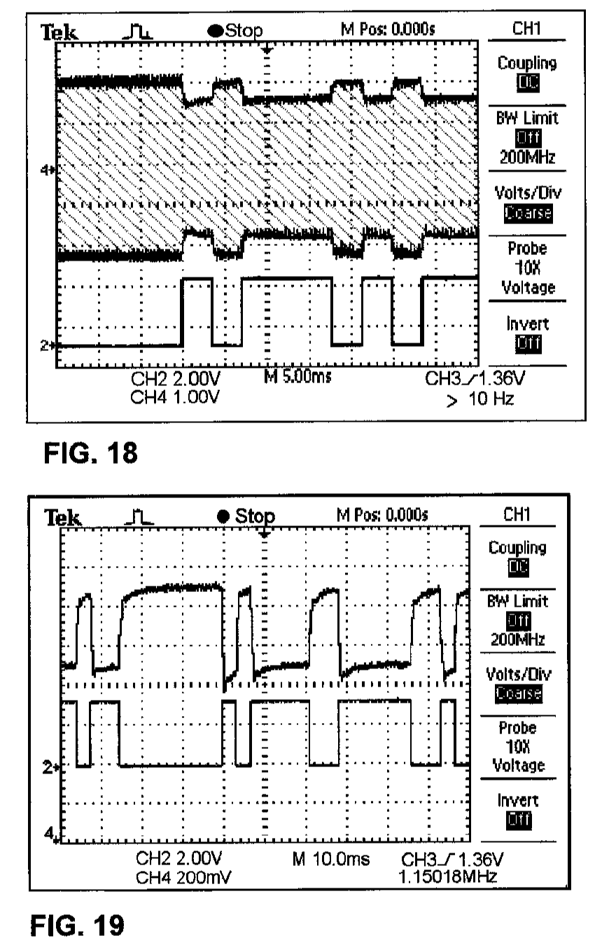

In FIG. 18, the voltage at the outside receive transducer in the three-transducer configuration is shown at the top of the screen. This trace was generated using the built-in peak detection function on the oscilloscope. The 1 MHz carrier is within the hatched area. The envelope is seen riding on this signal and is almost 1V in magnitude. The lower trace is the actual data that is being sent from the inside hardware at a rate of 280 bps. It can be seen that the logic level changes line up nicely with the changes in the received envelope. In FIG. 19, the output of the envelope detector circuitry is shown on top and the actual data is shown at the bottom. The carrier has been fully removed and the data lines up with the envelope. The transient seen between logic levels is a result of reverberations, and the resulting ISI, in the wall channel. This effect limits achievable data rates under the three transducer configuration.

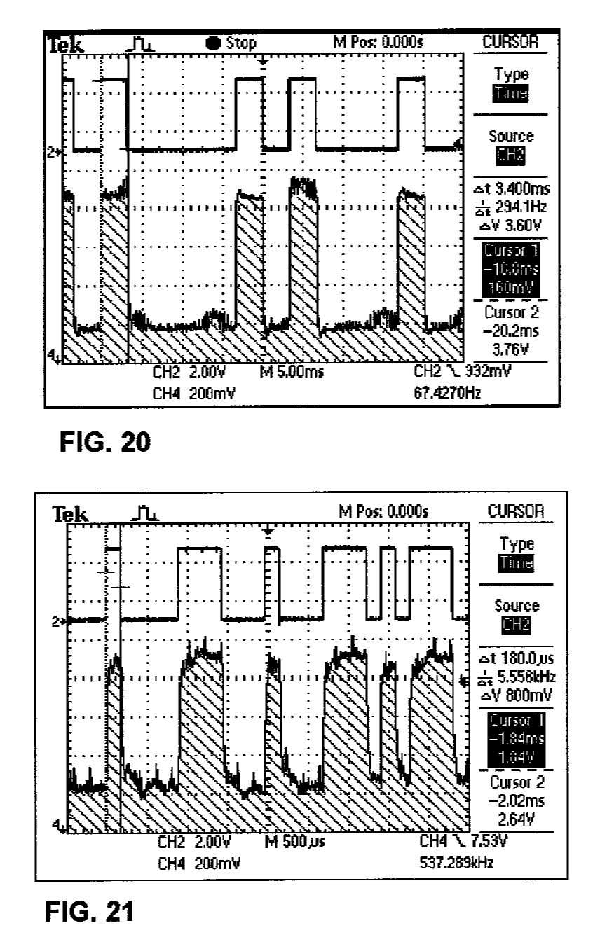

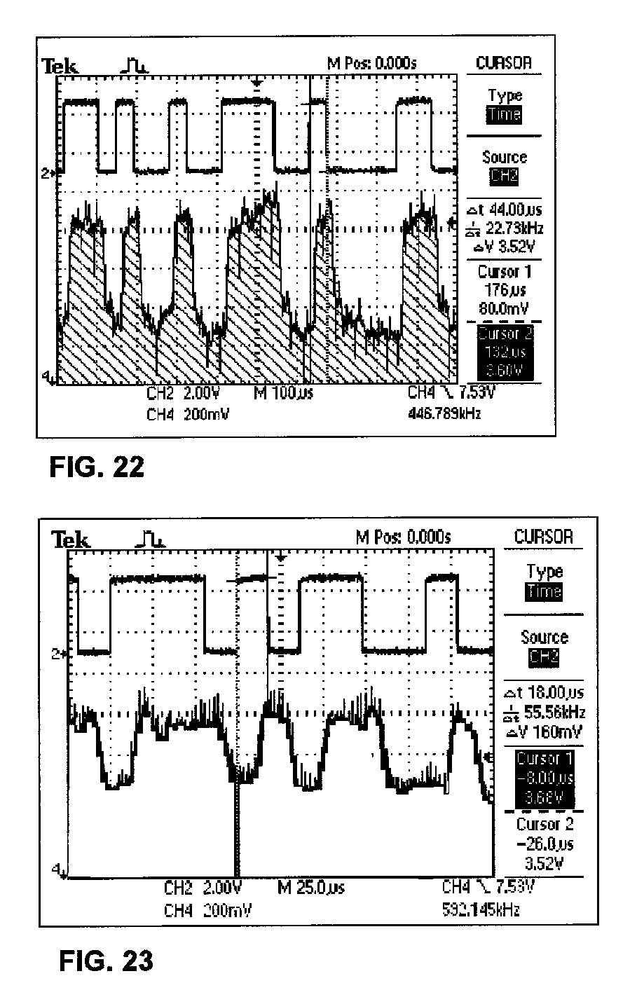

In FIG. 18 and FIG. 19, the envelope signals shown were detected at the receive transducer for the three-transducer configuration. For the two-transducer configuration, the ISI is drastically reduced, allowing for higher data rates. In FIG. 20, the envelope for the two-transducer configuration is shown on the bottom and the real data is shown on the top for a data rate of approximately 280 bps. It can be seen that the bit transitions are very square, warranting further increases in the data rate. In FIG. 21, the envelope is shown at 5 kbps. In FIG. 22, the envelope signal is shown at 20 kbps.

Finally, in FIG. 23, the envelope is seen at 50 kbps. Now, the data rate is approaching the same order of magnitude as the carrier frequency. Therefore, the carrier signal is no longer hatched out, and is shown as the bounded solid area at the bottom. Also, the envelope is slightly offset from the actual data, since the data period is approaching the channel delay time required for the ultrasound to propagate from the inside to the outside. All of these pictures were generated using the built in peak detection function on the oscilloscope. The envelope detection circuitry on the outside board presently cannot accommodate these high data rates but it can easily be adapted by modifying the filter bandwidths. As seen from these pictures, the two transducer configuration allows a very significant increase in data rate over the three transducer configuration.

### User Control Interface

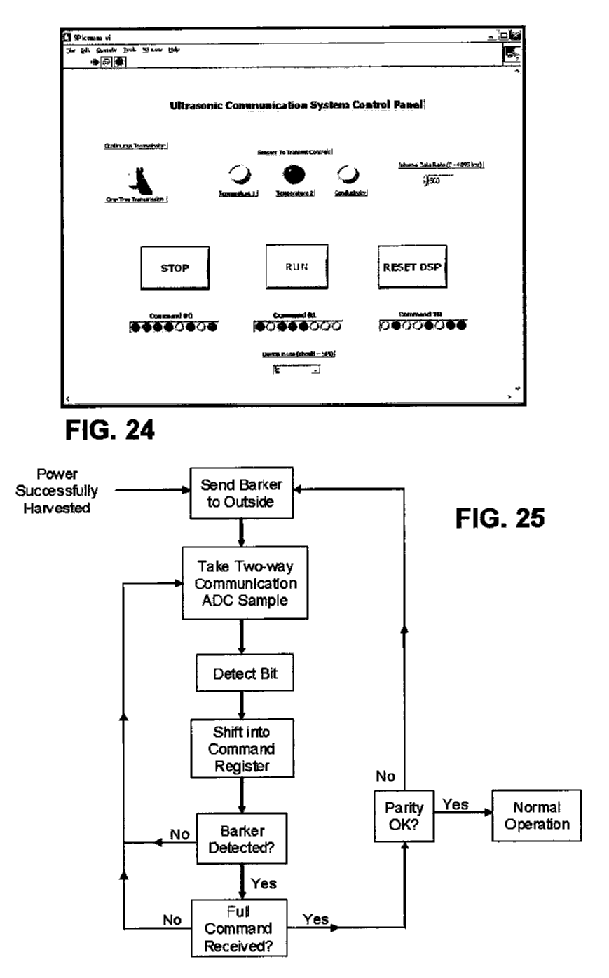

The addition of two-way communication capability creates the need for a way to input the commands for the inside board, enabling the user to set the various modes of system operation as desired. There are many possible control options with two-way communication. This section describes a LabVIEW-based graphical user interface (GUI) for entering commands as shown in FIG. 24. Many additional features can be added to this design in the future.

The GUI includes buttons, text boxes, and switches for entering the desired modes of operation based on user input. The program uses LabVIEW software with the NI-8451 I²C/SPI interface device by National Instruments. This device connects to the computer using a USB interface and receives serial commands from the LabVIEW software. The device then outputs serial streams to the DSP board using the SPI (Serial Peripheral Interface) protocol, which contain the commands to be sent to the inside circuit board. The DSP will then send these commands to the inside by AM modulating the carrier.

The three large buttons near the bottom of the interface are used to start and stop system operation. The “RESET DSP” button is used to restart the DSP program. The user would press this button to reinitialize the outside hardware. This reinitialization includes finding the optimal carrier frequency and initializing the outside circuit board. The switch on the top left of the GUI is used to setup continuous or one-time transmission modes. In one-time transmission mode, a set of sensor readings are chosen in the program and the command is sent to the inside circuit board. The inside circuit board will send back the desired data and wait for the next command. In continuous transmission mode, data from the selected sensors are continuously sent back from inside to outside until power is lost on the inside. It is envisioned that every time the inside circuit board powers up, it will wait for a new command. Therefore, in order to initiate a new command when operating in continuous mode, the carrier signal will be temporarily removed to stop power harvesting and reset the inside hardware. Once power is applied to the wall again, the inside circuitry will send back an acknowledgment sequence indicating that enough power has been gathered. A new command is then ready to be received.

The buttons across the top-middle portion of the GUI are used to select the sensors to be transmitted. At this time, two temperature sensors and a conductivity meter reside on the inside of the wall. Many more sensors could be multiplexed in the future, which would require additional buttons in the GUI. Finally on the top-right portion of the GUI, the data rate can be set. At this time, the data rate can be configured up to approximately 18.5 kbps. By adding additional command bits, higher data rates can be included in the commands. On the bottom of the program GUI, three commands, each 8-bits in length, are shown. These commands are compiled from user selections in the program and are sent via SPI to the DSP board. Anytime the state of a button or text box changes in the program, the updated command is sent to the DSP to indicate a change in system operating status. The DSP will proceed to power-down the inside circuit board if running in continuous mode, power back up again, and send the new command.

When the DSP is receiving the commands, the first two bits of each command indicate which command is being sent. For command 00, the first two bits are {0,0}. For command 10, the first two bits are {1,0}, and so on. Commands 10 and 01 are used to transmit the desired data rate to the DSP. Six bits of the full 12-bit data rate are sent per command byte. Command 00 is used to send all other sensor selection and operation mode information. When expanding to more extensive two-way communication functionality, more command bytes can be added. This change can be made by either using the first few bits to represent which command is being sent or, if the number of commands becomes too large, a new protocol could be developed. The protocol could initially send an 8-bit word to the DSP indicating which commands will be following. The next transmissions would represent the data from these commands. By selecting a LabVIEW software interface and USB based serial communication device, the user of the ultrasonic system needs only a laptop or desktop PC to control the communication system. In addition to having control over the system, the LabVIEW program can also be used in the future to display sensor readings. This display would replace the digital temperature display mentioned earlier in this disclosure. The DSP could easily be configured to forward all received sensor readings via serial stream to the NI-8451 serial device for input into the LabVIEW program. Once the sensor readings have been received by the computer, many options are available. Besides displaying the sensor readings, data logging could be performed and data analysis could be done either during operation or at a later time. Two-way communication and the computer interface offer many possibilities for future development and expandability of the ultrasonic communication system.

### Software Implementations And Algorithms

The DSP on the outside system and the CPLD on the inside system are programmable devices, and software and firmware has been developed to make them operate as desired. Additionally, software has been developed for the user interface. The DSP can be viewed as the main processing core of the system. The DSP controls the adjustments in both the transmit and receive signal chains of the outside circuit board. All sensor data decoding and processing is done within the DSP. The DSP sends commands to the inside hardware and then decodes the received data, while maintaining synchronization with the inside circuit board.

The CPLD controls the inside circuit board operation. The CPLD is comprised of a large number of logic gates and registers that are programmed to perform complex logic functions. The CPLD relies on a master clock generated from the received carrier signal. This clock is used to synchronize internal register updates and logic operations. The inside circuit board and outside hardware can be viewed as two separate transceivers in a standard communication system. The two systems need to work together to communicate sensor readings from the inside to the outside, and control signals from the outside to the inside.

A preliminary communication protocol for each system has been developed and implemented. This protocol provides each device (inside and outside) a certain time window to communicate while the other device is idle and listening. The result is a half-duplex mode of communication. This is a relatively simple approach for two-way communication and other more sophisticated approaches may be used in the future.

In this section, the software and algorithms developed for the DSP and CPLD will be described. Some emphasis will be placed on describing how the two devices work together and remain synchronized with one another through the various operation modes.

### CPLD Software Development For the Inside Circuit Board

Hardware description language code (HDL) has been written in Verilog to configure the CPLD. All operations in the CPLD are synchronized to a 1 MHz master clock generated from the received carrier signal. The internal program counter and data rates are derived from this clock, allowing for easy synchronization and knowledge of the data rate on the outside.

When sufficient power has been harvested, the inside circuit board is turned on and the CPLD executes a startup sequence. A flowchart of this startup sequence is shown in FIG. 25. The inside circuit board first needs to let the outside hardware know that it is alive and ready to transmit data. This is done by sending back a 7-bit Barker sequence (1110010) to the outside of the channel (ref. 6). Back on the outside, the DSP detects this sequence and is able to synchronize with the internal clock driving the outgoing data rate. Once synchronized, the DSP starts sending a command to the inside board, which is prefixed by the same 7-bit Barker sequence. The CPLD then detects the incoming command from the outside. Samples of the envelope detector output are taken from the ADC and compared to a threshold to determine if a logic 1 or logic 0 has been received. These detected bits are then shifted into the beginning of an internal 12-bit command register.

After each sample is taken, the CPLD searches the contents of the command register for a Barker sequence. If the Barker sequence is not detected, more samples are taken, bit decisions are made, and the bits are shifted into the command register. Once the Barker sequence is seen within the command register, the CPLD will begin waiting the appropriate number of clock cycles to receive the entire command. Samples are continuously taken during this time, one per data bit, and shifted into the command register. Once the full command has been received, a parity check is performed. The DSP guarantees even parity through a single parity bit in the transmitted command. If an even number of logic 1's are detected, the parity check is successful and the CPLD proceeds to execute the command. If the parity check is not successful, the CPLD will restart the startup sequence by sending back the Barker sequence. The parity bit enables single bit errors in the control sequence to be detected, reducing the chances of putting the inside board into an undesired mode of operation.

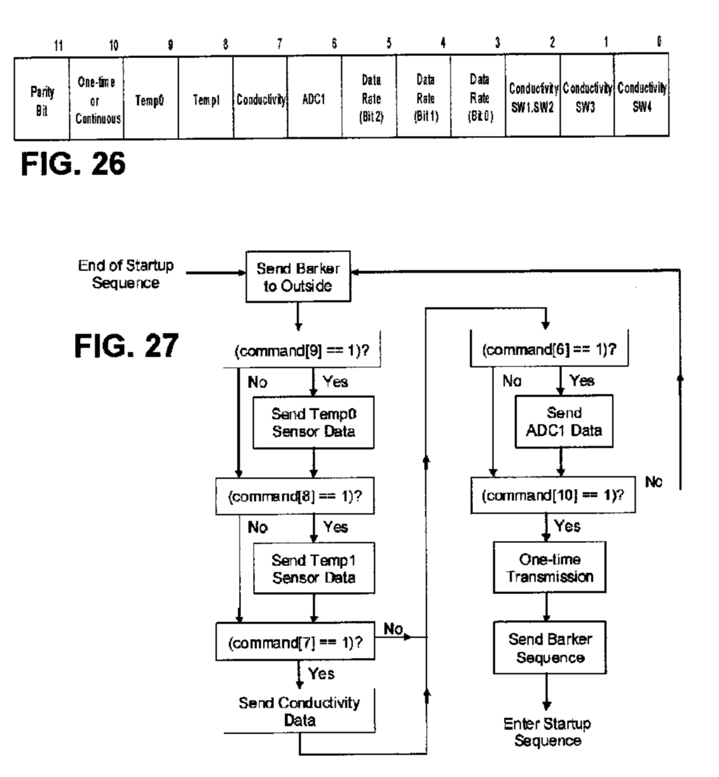

Once the startup sequence has completed, the CPLD enters its main program loop and normal operation mode. Here the CPLD sequence of operations is completely dependent upon the received command. The received command contains bits for each sensor, the data rate, and whether continuous or one-time transmission should be used. A diagram of the command word is shown in FIG. 26. Bit 11 is the parity bit. Bit 10 is used to set continuous or one-time transmission mode. Bits 9 through 6 are used to enable or disable inside circuit board sensors. Bits 5 through 3 are used to set the data rate for inside to outside communication. Bits 2 through 0 are used to configure the conductivity measurement ranges. The conductivity meter analog switch select lines are always set to be equal to these bits in the command register. The switches determine which resistor will be in the feedback path of the I-V converter, as shown previously in FIG. 11.

Once the startup sequence is complete, the main program loop is entered and executed as illustrated in FIG. 27. First a Barker sequence is sent to the outside. This sequence is used to establish synchronization to the inside-to-outside data stream for proper detection on the outside. Then if command[9], i.e. command bit 9, is a logic 1, sensor readings from the first temperature sensor will be sent back. Next, if command[8] is a logic 1, sensor readings from the second temperature sensor will be sent back. Next, command[7] represents whether or not conductivity measurements are desired. If command[7] is a logic 1, the conductivity data is sent back after all of the switches in the conductivity meter circuit are configured according to bits 2 through 0 of the command word. Next, if command[6] is a logic 1, data will be sent from the extra ADC channel on the inside circuit board. Finally, the main loop checks the command[10] bit. If command[10] is a logic 1, one-time only communication is desired, in which case the CPLD will send back one more Barker sequence and then enter back into the startup sequence. If continuous transmission is specified by command[10], then the main loop will restart and continue executing until power is lost. Thus, in order to exit continuous transmission mode, the carrier signal must be removed from the outside transducer so that power harvesting is stopped and power to the inside electronics is lost.

The last portion of the CPLD code adds the ability to change data rates based on bits 5 through 3 of the command word, providing a choice between 8 pre-determined data rates. The data rate is generated by dividing down the nominal 1 MHz master clock to the CPLD. Inside of the CPLD, all operations are synchronized and ordered through the use of a large program counter. This counter continuously counts and is reset to zero at variable times based on the desired data rate. Each time the program counter is reset, the serial clock (SCLK) for the sensors on the inside circuit board has its logic state flipped. The rate at which SCLK is generated determines the outgoing data rate. For example, if 1000 bps data rate is specified in the command word, SCLK will be flipped and the program counter will be reset every 512 program counter cycles, since two flips of SCLK will represent a full period, and 1 MHz divided by 1024 is approximately 1000 bps. If a data rate of approximately 8 kbps is desired, SCLK will be flipped every 64 program counter cycles and so on.

### DSP Software Development For the Outside Electronics

The DSP software, like the CPLD software, can be viewed in two main segments—the initialization sequences and the main program loop. When the DSP is reset through the user interface or upon power up, the initialization sequence is entered. After communication has been established with the inside circuit board, the DSP will then move into the main program loop. The DSP has two internal processors. The first is the core processor which does all the main processing and sensor data decoding. The second is the direct memory access (DMA) processor, which is used for serial data transfers. The DMA processor frees up the core processor to do processing of the received data, while maintaining a constant stream of input or output data. For example, a constant stream of samples is sent from the ADC to the DSP and stored in memory by the DMA processor until 50 data bits, or 350 ADC samples have been received. The DMA processor then generates an interrupt telling the core processor to start processing the received data. The DMA processor is used constantly during operation, since most of the outside functions and algorithms rely upon a constant stream of incoming ADC samples from the outside circuit board.

During the initialization procedure, the DSP first needs to establish communication with all the serial devices in the system. This process includes the user control interface and the ADC, DDS, and DAC components on the outside circuit board. All channels on the DAC are set to 0V, the DDS output frequency is initialized to 1 MHz, and the ADC serial clock is generated, initiating the incoming stream of ADC samples. The wall channel is then characterized to find the desired frequency for communication and power delivery to the inside circuit board. Currently this process is done through the use of a frequency sweep. The DDS sweeps frequencies in the range of 800 kHz to 1.2 MHz in 10 kHz increments. At each frequency, the DSP waits approximately 1 ms for the channel transients to die out and then measures the amplitude of the signal at the outside transducer. The channel is very frequency selective and, if a poor frequency is chosen, successful communication and power harvesting may be very hard to accomplish. During this process, the carrier signal is sampled at the output of the first stage of the received signal chain prior to any envelope detection. By taking a large number of samples at a high rate, the signal amplitude can be estimated.

After looping through all of the frequencies, the best four frequencies are stored. At this time, the best frequencies are assumed to be those that produce the largest received signal, though this may change as we further investigate the relationship between the power delivered to the inside and the signal amplitude at the outside. Another frequency sweep is performed around each of these four best frequencies using a smaller frequency increment. From these four sweeps, the optimal frequency is chosen where the largest signal on the outside transducer is seen. The frequency is then stored internally, since timing for the internal data rate, ADC sampling rate, and outgoing two-way communication commands are based on the carrier frequency. By performing the frequency sweep, the outside hardware is able to adapt to different channel conditions. The frequency sweep is performed at low power levels so that the inside circuit board does not turn on and start modulating the carrier wave envelope. While it is not currently incorporated into the code, the DSP code could also be configured to automatically run a frequency sweep when poor communication and system performance is being observed.

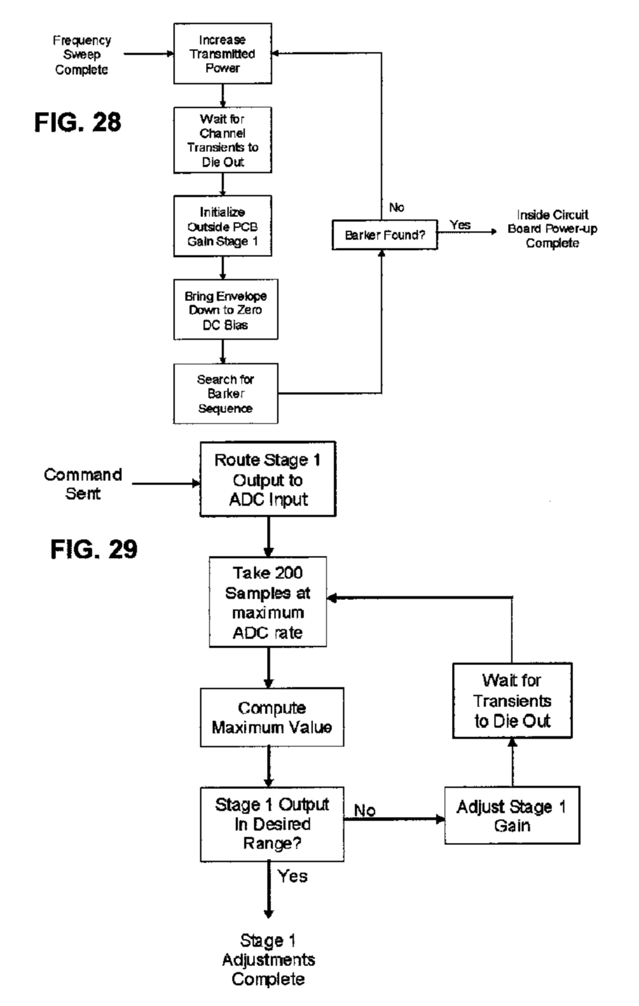

After the frequency sweep has been performed, the power being sent into the ultrasonic channel is progressively increased until communication from the inside circuit board is detected. This process is illustrated in FIG. 28. In order to increase the transmitted power, the gain of the carrier VGA is increased by increasing the DAC4 voltage. Between each increment of the gain, the DSP waits a set amount of time for the transients in the channel to die out and fully adjust to the new carrier amplitude. Then the DSP initializes the first two stages of the outside circuit board. The first stage amplifies the outside transducer signal to be in the full range of the VGA output. The second stage brings the envelope offset down to zero. The third stage performs the envelope gain, and is configured here for a gain of one. Typically the received envelope signal is large enough such that the Barker sequence can be detected before further amplifying the envelope. During normal operation, the envelope gain stage is important for guaranteeing reliable communication. Once the outside circuit board receive signal chain has been configured, the DSP searches a single DMA block (50 data bits) and tries to synchronize to the 7-bit Barker sequence transmitted by the inside circuit board after it powers up. If the sequence is not found, the transmitted power is further increased and the loop repeats.

After the inside circuit board 50 has been powered up, the inside board waits to receive a command. The DSP receives the desired command from the user control interface. If no command is received, the default command to transmit all sensors continuously will be sent. The command is sent by varying the amplitude of the transmitted carrier wave. The amplitude is only varied by 10 percent, since large amplitude changes may cause power to be lost on the inside, which would reset the inside circuit board and prevent reception of the command. The command data rate is generated by dividing down the carrier frequency. The data rate is currently pre-configured for approximately 1000 bps by dividing the 1 MHz carrier frequency by 1024. The inside board is pre-configured to expect this incoming data rate.

The inside circuit board only takes one sample per bit and does not do any complex synchronization procedures, since CPLD functionality and logic gates are limited. Therefore, the DSP must do extra processing to ensure that the command bits being sent are synchronized to the inside board so that each sample will be taken in the center of the bit. If a rising edge on the received envelope is detected at time tRE_outside the corresponding rising edge at the inside transducer tRE will equal tRE_outside minus td where td is the time delay for propagation of ultrasound through the wall. On each rising edge of SCLK on the inside board, a new data bit is sent when transmitting. When receiving a command, the circuit board samples the command envelope on the falling edge of SCLK. Therefore, in order to ensure proper sampling, the command bit should reach the inside of the channel at the rising edge of SCLK. This ensures that the falling SCLK will sample the center of the command bit. After the rising edge time is calculated, the next rising edge will occur at tRE_next which will be tRE plus Tdata where Tdata is the data period. Then, each command bit must be sent from the outside at time tsend_bit equals tRE minus td in order to take into account the channel propagation delay. Through the use of a timer structure in the DSP, the DSP is able to keep track of absolute time in order to send the command bits at the appropriate times.

Once the command is sent, the inside circuit board will begin to execute the command and send back a Barker sequence followed by data. The last step prior to the main program loop is the initialization of the outside circuit board receive signal chain. This step is performed multiple times during the power-up sequence and is performed once more after power-up is complete and the command has been sent. The outside circuit board can be considered to have three main stages when doing calibration. The first stage amplifies the 1 MHz signal from the outside transducer, the second stage brings the envelope down to zero DC, and the third stage amplifies the envelope. The first two stages are part of the initialization sequence. The third stage, the envelope gain, is done in the main program loop. A flowchart of the adjustments for the first stage is shown in FIG. 29.

In the first stage (FIG. 29), the analog switch on the outside circuit board is configured so that the output of stage one will be sampled directly, i.e. without envelope detection. The highest possible sample rate on the ADC (3 MSPS) is used here, since a nominal 1 MHz signal is being sampled. Two hundred samples are taken and then the maximum value is computed. The maximum value will represent the amplitude of the output of stage one. If the maximum value is large enough, but not so large where the input to the ADC is being clipped, then the stage one gain has been configured properly and stage one adjustments are complete. If the maximum value is not in this desired range, the gain of stage one is adjusted. This adjustment is done by calculating the necessary additional gain to achieve the maximum dynamic output range of the first VGA. A weighted average is performed so that changes in amplitude are not abrupt and the algorithm is always able to converge. Between each adjustment, the DSP waits for channel transients to die out and the gain adjustment to take effect before repeating the loop until the correct gain is achieved.

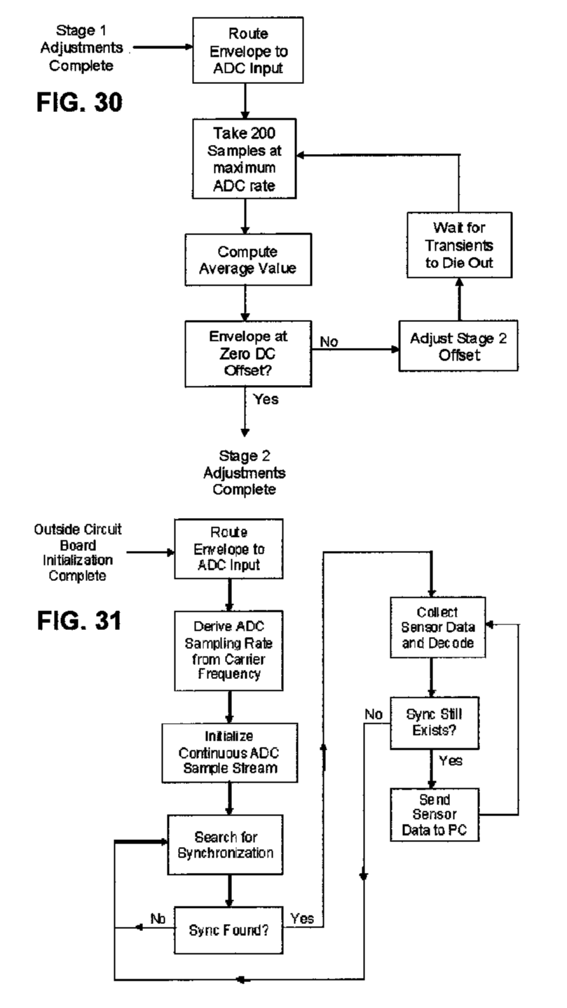

The second stage of the outside circuit board initialization procedure can be seen in FIG. 30. Here, the envelope detected signal is now routed to the ADC input through the analog switch. Again two hundred samples are taken at a very high ADC sample rate. When sampling the envelope at a high rate, the ADC will essentially see a DC input signal during the 200 samples, since the data rate is much lower than the sample rate. From these samples, the average value is computed. If the average value of the envelope samples represents a zero DC bias, then stage two adjustments are complete and the initialization sequence will be exited. If the average value does not represent a zero DC bias, the offset applied in stage two is adjusted to bring the average value down to zero DC. This adjustment is done through the use of a weighted average to make sure the changes in offset do not overshoot zero DC and the algorithm converges. Finally the DSP will wait for transients to die out and the new envelope offset to take effect before repeating the loop.

The output of this stage may not be exactly at zero DC since, by sampling at a high rate, the 200 ADC samples may all be part of a single data bit. In this case, the single data bit's offset is brought to zero, whereas in reality the data should be centered around zero DC. This does not present a problem because constant adjustments to the offset are made during the main program loop. Also, the bit decision threshold is continuously updated in the main loop so that even if the data is not exactly centered at zero, there will still be proper detection of the data. The high sampling rate makes the initialization sequence very fast, outweighing the initial reduction in offset cancellation precision. In the main program loop, ADC samples are taken at a slower rate and both logic levels are considered.

FIG. 31 is a flowchart for the main program loop in the DSP. Once the outside circuit board has been initialized and the command has been sent, the DSP is used to receive data from the inside circuit board by processing ADC samples from the filtered envelope detector output. For simplicity during this discussion, it is assumed that the inside circuit board has enough power readily available to operate continuously and the command that was sent specified continuous transmission mode. Therefore the data coming back from the inside consists of a 7-bit Barker sequence followed by data representing all the sensor outputs. This loop repeats continuously, with a Barker sequence preceding the data each time. The ADC sampling rate is set to seven times the data rate by configuring the serial interface clock frequency. The DMA processor is then initialized to provide a continuous stream of ADC samples.

When each new DMA block of ADC samples is filled, the remainder of the flowchart shown in FIG. 31 is executed. First the DSP searches for the 7-bit Barker sequence in the DMA block in an attempt to obtain synchronization. If the Barker sequence is found, then the DSP starts recovering the data. Seven samples per bit are still taken at this point, but only the middle sample is used for bit decisions. Once a complete transmission from the inside circuit board is detected and decoded, the DSP will verify that the next Barker sequence has been detected and synchronization still exists. If this is true, then the sensor readings are sent to the LCD display panel or sent to the PC via serial stream for displaying and data logging. If synchronization is not detected, then it is possible that synchronization was falsely made. The DSP will then restart the main loop and search for synchronization again.

When each DMA block is received, adjustments to the outside circuit board are also made. The DSP will detect the envelope offset by averaging all samples in the DMA block. If the offset is not zero, it will incrementally be brought back down to zero DC. The envelope signal's DC level tends to drift over time and these continuous updates will cancel this effect. Also for each DMA block, the gain of the third stage on the outside circuit board is configured to set the envelope gain. This adjustment is made by computing two averages, one of all of the samples above the bit decision threshold, and one of all samples below the bit decision threshold. By taking the difference between these averages, the dynamic range of the envelope can be estimated. From there, the appropriate gain adjustments can be made to bring the envelope into the desired dynamic range for reliable data detection.

### Synchronization

In order for the DSP to correctly process the envelope samples, the DSP first needs to synchronize to the incoming data stream. To facilitate this synchronization, transmissions from the inside circuit board are organized into frames consisting of a 7-bit Barker sequence followed by data from each sensor. In order to synchronize, the DSP collects a block of approximately 50 bits of data at 7 samples per data bit (350 total ADC samples). The exact DC offset of the envelope is then calculated in order to set the bit decision threshold, which should be close to zero. Once the threshold has been found, a bit decision is made on each sample in the block, with samples greater than the threshold stored as a ‘1’ and samples less than the threshold stored as a ‘−1’ in an array.

A sliding cross-correlation between the Barker sequence and this block of data is then performed. A peak in the correlation output indicates a possible location for synchronization. The correlation output is computed using the Barker sequence, with each bit (also called a chip) repeated 7 times, and using an array of ‘1’s and ‘−1’s that is generated from the ADC samples (ref. 6). The DSP takes the autocorrelation results and looks for the maximum. The maximum value is then compared to a threshold, where a correlation value above the threshold indicates the presence of the Barker sequence. The maximum possible correlation is 49, since there are 7 samples per bit and 7 bits in the Barker sequence, giving 49 total points in the summation. Peaks in a plot of the cross correlation output indicate the starting location of the Barker sequence, which is the location that the synchronization code is attempting to find.

Through testing, it has been determined that an appropriate correlation threshold for initial synchronization is approximately 45. Setting the threshold close to the maximum correlation of 49 reduces the chance that the DSP will synchronize to a portion of the data stream that is not the Barker sequence, which would then result in faulty data. The peak of the correlation calculation identifies the location of the first of 7 samples in the first bit of the Barker sequence. An offset of three samples from this location is then used to sample each bit, since the best performance will be seen when sampling each received data bit as close to its center point as possible. The above method for synchronization could be improved if bit decisions were not made prior to the cross-correlation process and the raw ADC values were used instead. This modification, while it would provide improved performance, is complicated to implement and has not been needed up to this point. As data rates are pushed higher and channel conditions worsen, this modification may become necessary.

Once the initial synchronization procedure has been completed, synchronization is verified at the arrival of each subsequent Barker sequence (from subsequent sets of data). The correlation at the expected Barker sequence starting point is calculated along with the correlation values of two ADC samples on either side of the expected starting point. The maximum of these 5 points is chosen as the next starting point of the next set of data bits. This value is also compared to a threshold to see if synchronization still exists. The threshold used for subsequent synchronizations is slightly smaller since less stringent requirements are needed once the initial synchronization procedure has been done properly. By looking at adjacent samples to the expected synchronization point, the synchronization algorithm becomes adaptive. It is able to adapt to small inconsistencies in clocking rates that potentially could lead to an accumulating drift that would eventually call for a full new synchronization procedure. By adapting and maintaining synchronization throughout, the algorithm is much less likely to have to undergo a full initialization procedure again, a process which consumes more time on the processor.

To test the performance of the adaptive part of the synchronization, while running at approximately 100 bps, the data rate of the inside circuit board was increased by 1 bps by applying a higher clock rate than the DSP expected to the inside circuit board. The DSP then sampled the system at the expected data rate, not taking into account the discrepancy introduced. Running for 200 data transmissions, without the adaptive algorithm, the synchronization was effective less than 70% of the time, while with the adaptive algorithm, the synchronization was able to track the drifting clocks and was effective 100% of the time.

### Interior Housing Design

A housing has been designed to protect the inside circuit board from the environment within the pressure vessel. In producing the design, it was desired to meet a number of conditions:

The housing must have cavities large enough to contain the circuit board and transducer.

The housing must be able to withstand large thermal transients without failure of housing or failure of circuit board or transducer as a result of different coefficients of thermal expansion.

The housing must be able to withstand large pressures without failure of housing or failure of circuit board or transducer as a result of compression.

If there is any seam in the housing, it must be designed to prevent the exterior pressure and fluid from entering the circuit board and transducer cavities.

The housing must be able to mount to a surface (this surface is assumed to be planar here) and prevent pressure and fluid from entering the circuit board and transducer cavities through this connection.

The transducer must be able to mount directly to the communication surface without any interference from the housing.

The housing should be as small as possible, considering the above constraints. Ports for the sensors can be attached directly to the housing wall; or they can be placed on its interior; or they can be communicated to wirelessly to regions external to the housing but elsewhere in the interior.

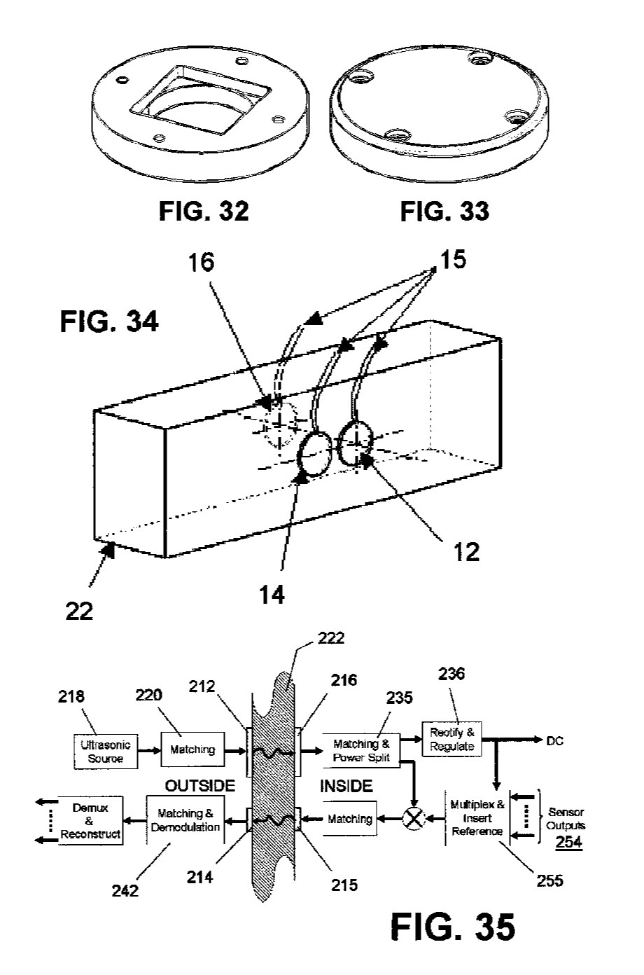

To start the design process, it was important to get accurate dimensions of the circuit board and transducer, and to arrange them such that they are as close and compact as possible, without the possibility of interference between the two. The housing design is shown in FIGS. 32 and 33. The housing or case has two parts—a bottom part shown in FIG. 32, a top part shown in FIG. 33. The parts were designed to be circular to prevent edges, minimize size while maximizing interior area, and to simplify machining. Shown are four screw holes that will be used to join the two pieces. Not shown is an o-ring grove that holds an o-ring that acts as a seal between the housing parts, preventing the pressure or fluid from the exterior from entering the interior of the housing.

Through the center of the bottom piece of FIG. 32, is a cylindrical hole slightly larger than the transducer for accommodating the inside transducer 16 of FIG. 2. The transducer is mounted to the wall and the housing is placed around the transducer, with the transducer in this hole and not in contact with the housing. This hole also allows space for the circuitry on the circuit board. This hole is continued into the bottom of the top piece, allowing additional space for the circuitry on the circuit board.

There is also a rectangular cut into the bottom piece as shown in FIG. 32, with the sides being slightly longer than the lengths of the circuit board. This cut allows the circuit board to be set into the cavity, and leaves room for the board to expand with temperature changes. The gap also makes room for wires to be run from one side of the board to the other, if needed. To hold the board in place, spacers are made out of a material with a low modulus of elasticity. The spacers fit over the circuit board's corners, and will be pinched between the top and bottom pieces, effectively holding them in place. Some sort of sealed cover (FIG. 33) is added to prevent penetration of liquid into the circuit, but can have sealed penetrations for communication to sensors exterior to the housing.

To mount the housing to the wall, for example as shown in the test setup of FIG. 34, epoxy is used on the bottom surface of the bottom piece and the wall. To ensure the epoxy does not fail at elevated temperatures, it is suggested that the housing material's coefficient of thermal expansion be selected to match that of the mounting surface. For testing purposes, a stainless steel will be used to construct the housing.

The inside circuit with its transducer and housing was successfully temperature tested to 150° F. in water using an autoclave.

### Further Preferred Embodiments

With reference to FIG. 35, a further embodiment of the invention utilizes a double-hop approach. Four transducers are provided in two pairs axially aligned on opposite sides of the wall. One pair 212 (outside) and 216 (inside) is used to convey a carrier signal from the outside to the inside. This received carrier is converted to an electrical signal by the inside transducer 216, modulated (using any of a wide variety of analog or digital modulation techniques) and fed to another inside transducer 215 which sends it to the other outside transducer 214.

Like the two and three-transducer embodiments of the invention disclosed previously, the double-hop technique has the advantage of not requiring an oscillator on the inside and being compatible with power harvesting. It has the added advantage of being compatible with many different modulation techniques while the previously disclosed embodiments are more adapted to amplitude modulation. Instead ultrasound is simply transmitted by one transducer in each pair and received by the other transducer. This has the limitation of requiring two inside transducers, however.

In FIG. 35, pulsed or continuous-wave (CW) ultrasound from a generator 218 is applied using a transducer 212 that is acoustically coupled to the outside of the wall 222 through an impedance matching network 220 that performs impedance matching between the source 218 and the transducer 212 for optimizing the power transfer to the transducer.

Transducer 216 which is acoustically coupled to the inside surface of the wall 222 receives this ultrasound and converts it into an electric signal in a matching and power splitting circuit 235. Part of the signal is fed to a rectifier and regulator 236 that acts as a power harvesting means to produce a direct current power source for the circuits and/or sensors. The remainder of the electric signal is modulated by sensor data and fed to the second inside transducer 215 which produces a modulated ultrasound signal that propagates to the outside wall.

Information from multiple sensors at 254 are multiplexed together and used to modulate the electric signal from circuit 235, by a multiplex and insert reference circuit 255. The second transducer 214 on the outside of the wall receives the modulated ultrasound and converts it into an electric signal which is demodulated to recover the sensor data. If the information stream contains the multiplexed data from multiple sensors, a de-multiplexing operation at 242 is used to isolate the information from the individual sensors.

The modulation of the electric signal which, through the ultrasonic transducer, produces the modulated ultrasound signal, is represented in the diagram as a multiplication of the received ultrasound “carrier” by the sensor data. In practice, one of many analog or digital modulations can be used such as, for instance, amplitude modulation, phase modulation, phase-shift keying, amplitude-shift keying, and on-off keying. With analog modulations, it may be necessary to insert periodic reference signals into the stream to enable the receiver on the outside to detect the propagation characteristics of the return path and properly reconstruct the sensor signal(s). For instance, in an analog amplitude modulation system, the unknown attenuation of the paths through the wall and gain of the modulator would make it impossible for the receiver to know the actual voltage level that is being sent. However, the periodic insertion of a known voltage level into the transmit stream would enable the receiver to learn the effective gain and offset of the system and properly reconstruct the sensor voltage.

A major advantage of the double-hop system is that the ultrasonic carrier signal, either a series of pulses or CW, is generated on the outside of the wall and conveyed to the inside where it is modulated with the data. Consequently, neither an oscillator nor a pulser is required on the inside thereby reducing both the electric power requirements and complexity of the inside circuitry. In addition the demodulation of the returned signal on the outside is simplified by having precise knowledge of the carrier signal, e.g. the timing of the pulses or frequency of the CW signal.

With both pulses and CW, one complication of this approach stems from the direct coupling of power between the two outside transducers, primarily through reflections within the wall. In this case unmodulated ultrasound carrier or, at least, carrier that is not modulated by the sensor data, arrives at the outside receive transducer in addition to the desired modulated carrier that contains the sensor data. In the case of a pulse carrier, the shortest path from the carrier source to the receiver is through the electric circuits on the inside side of the wall due to the much higher propagation velocity of the electric signal over the acoustic signal. The only exception may be shear waves traveling along the outside wall between the transducers which, through the proper selection of transducers, will be insignificant. Consequently, the first pulse to arrive at the outside receive transducer after the application of a pulse to the outside transmit transducer will be the one modulated by the sensor data. Subsequent pulse “echoes” will include unwanted signals arriving through direct acoustic paths and these can be removed by appropriate time gating. The repetition rate for the applied pulses must be kept sufficiently low to avoid introducing overlap between the desired modulated pulses and other reflected pulses.

For CW modulation, direct acoustic paths between the two transducers on the outside of the wall will result in the generation of a standing wave arrangement and the application of an unmodulated CW signal to the receive transducer on the outside of the wall. This CW “interferer” may add constructively or destructively with the desired modulated signal. Depending on the type of modulation being used, the demodulator may have to suppress this CW interferer to properly recover the sensor data. Since the CW interferer is present at all times, time gating is not effective in this case as it was with a pulsed carrier.

The generation of a DC power source on the inside can be performed using the “power harvesting” approaches. Finally, two-way communication is possible using this approach by modulating the carrier applied to the outside of the wall. A receiver on the inside can demodulate this carrier to recover the data being conveyed from the outside to the inside. For conveying sensor data from the inside to the outside, the carrier received at the inside, which has already been modulated with the data from the outside, can be modulated a second time using the sensor data. Depending on the modulation being used, the receiver on the outside will make use of the known data transmitted from outside to inside and/or the actual modulated carrier sent from outside to inside in the demodulation process.

### REFERENCES

[1] T. L. Murphy, “Ultrasonic Digital Communication System for a Steel Wall Multipath Channel: Methods and Results,” M.S. Thesis, Rensselaer Polytechnic Institute, Troy, N.Y., USA, 2005.

[2] G. J. Saulnier, H. A. Scarton, A. J. Gavens, D. A. Shoudy, T. L. Murphy, M. Wetzel, S. Bard, S. Roa-Prada, and P. Das, “Through-Wall Communication of Low-Rate Digital Data Using Ultrasound,” 2006 Ultrasonics Symposium Proceedings, October 2006, pp. 1385-1389.

[3] Y. Hu, X. Zhang, J. Yang and Q. Jiang, “Transmitting Electric Energy Through a Metal Wall by Acoustic Waves Using Piezoelectric Transducers,” IEEE Trans. on Ultrasonics, Vol. 50, No. 7, pp 773-781, July 2003.

[4] M. Ferrari, V. Ferrari, D. Marioli, and A. Taroni, “Modeling, Fabrication and Performance Measurements of a Piezoelectric Energy Converter for Power Harvesting in Autonomous Microsystems,” IEEE Trans. on Instrumentation and Measurement, Vol. 55, No. 6, pp 2096-2101, December 2006.

[5] M. Guan and W. Liao. “Comparative Analysis of Piezoelectric Power Harvesting Circuits for Rechargeable Batteries,” Proc. of the 2005 IEEE International Conference on Information Acquisition, July 2005, pp. 243-246.

[6] J. B. Anderson, Digital Transmission Engineering, 2^{nd} Ed. New York: John Wiley & Sons, Inc., 1999.

[7] P. M. Lin and L. O. Chua. “Topological Generation and Analysis of Voltage Multiplier Circuits,” IEEE Transactions on Circuits and Systems, Vol. CAS-24, No. 10, October 1977, pp. 517-530.

[8] A. S. Sedra and K. C. Smith. Microelectronic Circuits, 5^{th} Ed. New York: Oxford University Press, 2004.

[9] J. G. Proakis and S. Masoud. Communication Systems Engineering, 2^{nd} Ed. New Jersey: Prentice-Hall, Inc., 2002.

[10] R. T. da Rocha, I. G. R. Gutz, and C. L. do Lago. “A Low-Cost and High-Performance Conductivity Meter,” Journal of Chemical Education, Vol. 74, No. 5, May 1997, pp. 572-574.

[11] P. Hawkins. “A Low-Powered Resistance and Conductivity Measuring Circuit for use with Remote Transducers,” Measurement and Science Technology, Issue 9, September 1990, pp. 845-847.

[12] S. Franco. Design with Operational Amplifiers and Analog Integrated Circuits, 3^{rd} Ed. Boston: McGraw Hill, 2002.

While specific embodiments of the invention have been shown and described in detail to illustrate the application of the principles of the invention, it will be understood that the invention may be embodied otherwise without departing from such principles.

1. An apparatus for communicating information between an inside and an outside of a wall, comprising:
at least one outside ultrasonic transducer acoustically coupled to an outside surface of the wall for sending an ultrasonic carrier signal into the wall and for receiving a reflected output information containing ultrasonic signal from the wall;
at least one inside ultrasonic transducer acoustically coupled to an inside surface of the wall for receiving the ultrasonic carrier signal and for generating and sending the reflected output information containing ultrasonic signal into the wall;
a carrier generator connected to the at least one outside ultrasonic transducer for driving the at least one outside ultrasonic transducer to generate the ultrasonic carrier signal;
detector means connected to the at least one outside ultrasonic transducer for detecting the reflected output information in the information containing ultrasonic signal; and
sensor means connected to the at least one inside ultrasonic transducer for reading information on the inside of the wall and for supplying the information to the inside ultrasonic transducer for generating the reflected output information containing ultrasonic signal.

2. The apparatus of claim 1, including only one outside ultrasonic transducer connected to the carrier generator and to the detector means, the one inside transducer being driven only by the ultrasonic carrier signal from outside the wall.

3. (canceled)

4. The apparatus of claim 1, including two outside ultrasonic transducers comprising a transmitter transducer connected to the carrier generator and a receiver transducer connected to the detector means, there being two inside transducers which are both driven only by the ultrasonic carrier signal from outside the wall, one of the inside transducers being for only receiving the ultrasonic carrier signal, and the other inside transducer being only for sending the reflected output information containing ultrasonic signal into the wall.

5. The apparatus of claim 1, including a power harvesting circuit connected to the inside transducer on the inside of the wall, for harvesting power from the ultrasonic carrier signal supplied to the power harvesting circuit by the inside transducer, the power harvesting circuit being connected to the sensor means for powering the sensor means.

6. The apparatus of claim 1, including a power harvesting circuit connected to the inside transducer on the inside of the wall, for harvesting power from the ultrasonic carrier signal supplied to the power harvesting circuit by the inside transducer, the power harvesting circuit being connected to the sensor means for powering the sensor means, the power harvesting circuit comprising a voltage rectifier for rectifying the ultrasonic carrier signal from the inside transducer, a storage capacitor connected to the voltage rectifier for storing a charge, a voltage regulator connected to the storage capacitor for supplying a regulated voltage to the sensor means, and a control circuit connected to the voltage regulator to control the voltage regulator to supplying a regulated voltage to the sensor means only when there is enough charge stored in the storage capacitor for operating the sensor means.

7. The apparatus of claim 1, including a power harvesting circuit connected to the inside transducer on the inside of the wall, for harvesting power from the ultrasonic carrier signal supplied to the power harvesting circuit by the inside transducer, the power harvesting circuit being connected to the sensor means for powering the sensor means, the power harvesting circuit comprising a voltage rectifier for rectifying the ultrasonic carrier signal from the inside transducer, a storage capacitor connected to the voltage rectifier for storing a charge, a voltage regulator connected to the storage capacitor for supplying a regulated voltage to the sensor means, and a control circuit connected to the voltage regulator to control the voltage regulator to supplying a regulated voltage to the sensor means only when there is enough charge stored in the storage capacitor for operating the sensor means, the control circuit being structured to use low power to have a hysteresis behavior and to operate from a variable voltage source.

8. The apparatus of claim 1, including a power harvesting circuit connected to the inside transducer on the inside of the wall, for harvesting power from the ultrasonic carrier signal supplied to the power harvesting circuit by the inside transducer, the power harvesting circuit being connected to the sensor means for powering the sensor means, the sensor means comprising at least one sensor for sensing a condition inside the wall to create a sensor signal, a logic device connected to the sensor for converting the sensor signal to a modulation signal, and a modulation device connected to the logic device and to the inside transducer for modulating the ultrasonic carrier signal with the modulation signal to create the reflected output information containing ultrasonic signal.

9. The apparatus of claim 1, including a power harvesting circuit connected to the inside transducer on the inside of the wall, for harvesting power from the ultrasonic carrier signal supplied to the power harvesting circuit by the inside transducer, the power harvesting circuit being connected to the sensor means for powering the sensor means, the sensor means comprising at least one sensor for sensing a condition inside the wall to create a sensor signal, a logic device connected to the sensor for converting the sensor signal to a modulation signal, and a modulation device connected to the logic device and to the inside transducer for modulating the ultrasonic carrier signal with the modulation signal to create the reflected output information containing ultrasonic signal, the modulation device acting on the inside transducer to change an acoustic impedance if the inside transducer using the modulation signal.

10. The apparatus of claim 1, including a power harvesting circuit connected to the inside transducer on the inside of the wall, for harvesting power from the ultrasonic carrier signal supplied to the power harvesting circuit by the inside transducer, the power harvesting circuit being connected to the sensor means for powering the sensor means, the sensor means comprising at least one sensor for sensing a condition inside the wall to create a sensor signal, a logic device connected to the sensor for converting the sensor signal to a modulation signal, and a modulation device connected to the logic device and to the inside transducer for modulating the ultrasonic carrier signal with the modulation signal to create the reflected output information containing ultrasonic signal, the modulation device comprising a switch for acting on the inside transducer for alternately opening and shorting the inside transducer according to the modulation signal.

11. The apparatus of claim 1, including a power harvesting circuit connected to the inside transducer on the inside of the wall, for harvesting power from the ultrasonic carrier signal supplied to the power harvesting circuit by the inside transducer, the power harvesting circuit being connected to the sensor means for powering the sensor means, the sensor means comprising at least one sensor for sensing a condition inside the wall to create a sensor signal, a logic device connected to the sensor for converting the sensor signal to a modulation signal, and a modulation device connected to the logic device and to the inside transducer for modulating the ultrasonic carrier signal with the modulation signal to create the reflected output information containing ultrasonic signal, the modulation device comprising a MOSFET connected to the inside transducer for alternately opening and shorting the inside transducer according to the modulation signal.

12. The apparatus of claim 1, including input information means connected to the at least one outside ultrasonic transducer for supplying input information to the inside of the wall by modulating the ultrasonic carrier signal, and a further detector means connected to the inside ultrasonic transducer for detecting modulations of the ultrasonic carrier signal to extract the input information from the ultrasonic carrier signal.

13. The apparatus of claim 1, including input information means connected to the at least one outside ultrasonic transducer for supplying input information to the inside of the wall by modulating the ultrasonic carrier signal, and a further detector means connected to the inside ultrasonic transducer for detecting modulations of the ultrasonic carrier signal to extract the input information from the ultrasonic carrier signal, the first mentioned and the further detector means each comprising an envelope detector for respectively detecting the input and the output information.

14. The apparatus of claim 1, including input information means connected to the at least one outside ultrasonic transducer for supplying input information to the inside of the wall by modulating the ultrasonic carrier signal, and a further detector means connected to the inside ultrasonic transducer for detecting modulations of the ultrasonic carrier signal to extract the input information from the ultrasonic carrier signal, the first mentioned and the further detector means each comprising an envelope detector for respectively detecting the input and the output information, the apparatus further including a power harvesting circuit connected to the inside transducer on the inside of the wall, for harvesting power from the ultrasonic carrier signal supplied to the power harvesting circuit by the inside transducer, the power harvesting circuit being connected to the sensor means for powering the sensor means, the power harvesting circuit comprising a voltage rectifier for rectifying the ultrasonic carrier signal from the inside transducer, a storage capacitor connected to the voltage rectifier for storing a charge, a voltage regulator connected to the storage capacitor for supplying a regulated voltage to the sensor means, and a control circuit connected to the voltage regulator to control the voltage regulator to supplying a regulated voltage to the sensor means only when there is enough charge stored in the storage capacitor for operating the sensor means.

15. The apparatus of claim 1, wherein the carrier generator generates a continuous wave ultrasonic carrier wave at a frequency which is selected to substantially match a resonant peak of all of the outside and inside transducers.

16. (canceled)

17. (canceled)

18. An apparatus for communicating information between an inside and an outside of a wall, comprising:
at least one outside ultrasonic transducer acoustically coupled to an outside surface of the wall for sending an ultrasonic carrier signal into the wall and for receiving a reflected output information containing ultrasonic signal from the wall;
an inside ultrasonic transducer acoustically coupled to an inside surface of the wall for generating and sending the reflected output information containing ultrasonic signal into the wall;
a carrier generator connected to the at least one outside ultrasonic transducer for driving the at least one outside ultrasonic transducer to generate the ultrasonic carrier signal;
detector means connected to the at least one outside ultrasonic transducer for detecting the reflected output information in the information containing ultrasonic signal;
sensor means connected to the inside ultrasonic transducer for reading information on the inside of the wall and for supplying the information to the inside ultrasonic transducer for generating the reflected output information containing ultrasonic signal; and
a power harvesting circuit connected to the inside transducer on the inside of the wall, for harvesting power from the ultrasonic carrier signal supplied to the power harvesting circuit by the inside transducer, the power harvesting circuit being connected to the sensor means for powering the sensor means, the power harvesting circuit comprising a voltage rectifier for rectifying the ultrasonic carrier signal from the inside transducer, a storage capacitor connected to the voltage rectifier for storing a charge, a voltage regulator connected to the storage capacitor for supplying a regulated voltage to the sensor means, and a control circuit connected to the voltage regulator to control the voltage regulator to operate in a burst mode for supplying a regulated voltage to the sensor means only when there is enough charge stored in the storage capacitor for operating the sensor means.

19. The apparatus of claim 18, including input information means connected to the at least one outside ultrasonic transducer for supplying input information to the inside of the wall by modulating the ultrasonic carrier signal, and a further detector means connected to the inside ultrasonic transducer for detecting modulations of the ultrasonic carrier signal to extract the input information from the ultrasonic carrier signal.

20. The apparatus of claim 18, including only one outside ultrasonic transducer connected to the carrier generator and to the detector means, the one outside ultrasonic transducer being axially aligned with the inside ultrasonic transducer across the wall, the inside transducer being driven only by the ultrasonic carrier signal from outside the wall, the carrier generator generating a continuous wave ultrasonic carrier wave at a frequency which is selected to substantially match a resonant peak of all of the outside and inside transducers.

21. (canceled)

22. An apparatus for communicating information between an inside and an outside of a wall, comprising:
two outside ultrasonic transducer acoustically coupled to an outside surface of the wall for respectively sending an ultrasonic carrier signal into the wall, and for receiving a reflected output information containing ultrasonic signal from the wall;
two inside ultrasonic transducers acoustically coupled to an inside surface of the wall for respectively receiving the ultrasonic carrier signal, and for sending the reflected output information containing ultrasonic signal into the wall;
a carrier generator connected to one of the outside ultrasonic transducer for driving the one outside ultrasonic transducer to generate the ultrasonic carrier signal to be supplied to one of the inside transducers;
detector means connected to the other outside ultrasonic transducer for detecting the reflected output information in the information containing ultrasonic signal; and
sensor means connected to the other inside transducer for reading information on the inside of the wall and for supplying the information to the inside ultrasonic transducer for generating the reflected output information containing ultrasonic signal.

23. The apparatus of claim 22, including a power harvesting circuit connected to the one inside transducer for harvesting power from the ultrasonic carrier signal supplied to the power harvesting circuit by the one inside transducer, the power harvesting circuit being connected to the sensor means for powering the sensor means, the power harvesting circuit comprising a voltage rectifier for rectifying the ultrasonic carrier signal from the inside transducer, a storage capacitor connected to the voltage rectifier for storing a charge and a voltage regulator connected to the storage capacitor for supplying a regulated voltage to the sensor means.

24. The apparatus of claim 22, wherein the carrier generator generates a continuous wave ultrasonic carrier wave at a frequency which is selected to substantially match a resonant peak of all of the outside and inside transducers.

25. (canceled)
